(19) United States
(12) Patent Application Publication
(10) Pub. No.: US 2026/0262570 A1
(43) Pub. Date: Sep. 10, 2026

(54) SYSTEM AND METHOD FOR MEASURING LOSS OF USEABLE PORTIONS OF CROP DURING HARVEST

(71) Applicant: Tyler Gaye Peniuk, Sturgis (CA)

(72) Inventors: Tyler Gaye Peniuk, Sturgis (CA); Jarrett Christian Wingerak, Theodore (CA)

(21) Appl. No.: 19/559,456

(22) Filed: Mar. 6, 2026

Related U.S. Application Data
(60) Provisional application No. 63/768,069, filed on Mar. 6, 2025.

(51) Int. Cl. A01D 41/127

(52) U.S. Cl. CPC A01D 41/1273

(57) ABSTRACT

A loss measurement system is provided for use in combination with a combine harvester. The system comprises: at least one rail mounted to the combine harvester; and a collection pan configured to be slidably received on the at least one rail. The collection pan comprises: a receptacle portion for receiving a sample of material from the combine harvester; and a cover portion for covering the receptacle portion. The system further comprises a retention system configured to retain both the receptacle portion and the cover portion of the collection pan and operable to switch between at least: a retain mode in which both the receptacle portion and the cover portion are retained; and a partial release mode in which the receptacle portion is released and the cover portion is retained, causing the receptacle portion to slide along the at least one rail and separation of the cover portion and the receptacle portion.

### RELATED PATENTS AND/OR APPLICATIONS

This application claims the benefit of U.S. provisional application No. 63/768069, titled “SYSTEM AND METHOD FOR MEASURING LOSS OF USEABLE PORTIONS OF CROP DURING HARVEST”, filed on Mar. 6, 2025, and incorporated herein by reference.

### TECHNICAL FIELD

This disclosure generally relates to a loss measurement system for use in combination with a combine harvester. More specifically, this disclosure relates to a loss measurement system including at least one rail mounted to a rear portion of the combine harvester and a collection pan configured to be slidably received on the at least one rail, wherein the collection pan includes a receptacle portion and a cover portion. The receptacle portion may be independently released relative to the cover portion, and when released, the receptacle portion slides along the at least one rail and is exposed to allow the receptacle portion to receive a sample of material discharged from the combine harvester.

### BACKGROUND

Combine harvesters are a type of agricultural implement able to travel along the ground to harvest crop growing on the ground, separate grain of the crop from chaff and straw of the crop, collect the grain into a hopper, and discharge the chaff and the straw from the combine harvester. However, the combine harvester may sometimes also discharge some portion of the grain with the chaff and the straw. The amount of usable grain discharged by the combine harvester may depend on operational parameters of the combine harvester, potentially in combination with the condition of the crop on the ground (e.g., moisture content) and weather at the field location (e.g., humidity). For example, with respect to the operation parameters of the combine harvester, a fan speed and sieve opening size of a residue management unit, a speed of travel of the combine harvester, a concave distance and a rotation speed of a threshing unit, and a height of a header are all operational parameters which can be adjusted to reduce grain loss.

It is desirable to reduce grain loss as grain loss directly translates into profit loss for a farmer. A common system for gauging grain loss is “drop pans” or “collection pans” which are attached to a combine harvester and then dropped during operation of the combine harvester to collect the chaff and the straw discharged from the combine harvester. An operator of the combine harvester can then assess how much of the discharged material includes usable grain and adjust the operation parameters of the combine harvester.

However, existing drop pan systems often involve a magnetic attachment of a drop pan to the combine harvester and include these magnetic attachments at fixed positions along the drop pan. See, for example U.S. Pat. No. 10,932,411 , issued Mar. 2, 2021 and titled “DROP PAN SYSTEM AND SAMPLE SEPARATOR FOR GRAIN LOSS MEASUREMENT OR OTHER SAMPLE COLLECTION AND ASSESSMENT,” and U.S. Pat. No. 10,653,065 , issued filed May 19, 2020 and titled “GRAIN LOSS MEASUREMENT SYSTEM FOR COMBINE HARVESTER.” However, the magnetic attachment used in these existing systems may not be easily or securely used with combine harvesters which do not have an appropriate flat surface upon which to mount the magnetic attachments. Further, the magnetic attachment used in these existing systems often results in a substantially vertical drop from the combine harvester, which may not be desirable depending on a travel speed of the combine harvester and/or a size of the combine harvester. For example, a slow-moving or a large combine harvester may deposit a significant amount of discharge material on a drop pan which is dropped too early and too close to the combine harvester, potentially making the sample of the discharged material too voluminous for the drop pan or more onerous to analyze. Further still, the existing systems may not be sufficiently modular to allow for use with different combine harvesters of different sizes. In this regard, because the magnetic attachments are often integrated into the drop pans as a single unit, a whole different drop pan system may need to be purchased for different combine harvesters of different sizes.

A different and more modular mechanism for releasing a drop pan from a combine harvester, and which may be used across a large variety of different combine harvesters, would be desirable to reduce the costs associated with measuring grain loss. Further, it may also be desirable to be able to assess grain loss immediately and simply while at the field location without using any complex machinery that can be easily damaged.

### SUMMARY

In one embodiment, there is provided a loss measurement system for use in combination with a combine harvester operable to cut a crop to be harvested, separate usable portions of the crop from unusable portions of the crop, and discharge material comprising both the usable portions and the unusable portions. The system comprises: at least one rail mounted to a rear portion of the combine harvester; and a collection pan configured to be slidably received on the at least one rail. The collection pan comprises: a receptacle portion for receiving a sample of the material discharged from the combine harvester; and a cover portion for covering the receptacle portion. The system further comprises a retention system configured to retain both the receptacle portion and the cover portion of the collection pan, the retention system operable to switch between at least: a retain mode in which the retention system retains both the receptacle portion and the cover portion; and a partial release mode in which the retention system releases the receptacle portion and retains the cover portion, causing the receptacle portion to slide along the at least one rail and causing separation of the cover portion and the receptacle portion to allow the receptacle portion to receive the sample.

The at least one rail may comprise at least two rails, wherein a rail of the at least two rails may be operable to be mounted to a location on a combine component of the combine harvester independently of another rail of the at least two rails.

The at least one rail may comprise one rail operable to be mounted to a location on a combine component of the combine harvester via a mounting component.

The mounting component may comprise at least one of a binding-based mounting component, a magnet-based mounting component, and a vacuum suction-based mounting component.

The receptacle portion may comprise at least one rail channel configured to receive the at least one rail.

The at least one rail may comprise a sliding component, wherein when the at least one rail is mounted to the rear portion of the combine harvester, the sliding component may be positioned at an acute angle relative to a ground over which the combine harvester travels.

The receptacle portion may comprise a screening component configured to facilitate separation of the usable portions in the sample from the unusable portions in the sample.

The system may further comprise a mobile gauge system comprising a carrying case and a calibrated container for receiving the usable portions in the sample received on the receptacle portion, wherein the carrying case may be configured to carry the calibrated container when closed and to retain the calibrated container in a vertical position when opened.

The receptacle portion may comprise at least one fold line to facilitate transfer of the usable portions in the sample from the receptacle portion to the calibrated container.

The retention system may comprise a receptacle retaining component configured to retain and release the receptacle portion in response to a wireless signal from a controller and a cover retaining component configured to retain the cover portion independently of the receptacle retaining component.

The cover retaining component may be further configured to release the cover portion in response to a further wireless signal from the controller.

The retention may be is operable to switch between the retain mode, the partial release mode and a full release mode in which the retention system releases both the receptacle portion and the cover portion.

The receptacle retaining component may comprise at least one of: an actuatable hook configured to rotate in response to the wireless signal from the controller; and an electromagnet configured to demagnetize in response to the wireless signal from the controller.

After the receptacle portion slides along the at least one rail, the receptacle portion may be deposited onto the ground over which the combine harvester travels.

In another embodiment, there is provided a method of measuring loss based on material discharged from a combine harvester, wherein the combine harvester is operable to cut a crop to be harvested, separate usable portions of the crop from unusable portions of the crop, and discharge material comprising both the usable portions and the unusable portions. The method comprises causing a retention system to switch from a retain mode in which the retention system retains both a receptacle portion and a cover portion of a collection pan and a partial release mode in which the retention system releases the receptacle portion and retains the cover portion. When the retention system is in the retain mode, the receptacle portion is covered by the cover portion. When the retention system is in the partial release mode, the receptacle portion slides along at least one rail mounted to a rear portion of the combine harvester and is separated from the cover portion to allow the receptacle portion to receive a sample of the material discharged from the combine harvester.

When the at least one rail comprises at least two rails, the method may further comprise independently mounting each rail of the at least two rails to different locations on a combine component of the combine harvester. When the at least one rail comprises one rail, the method may further comprise mounting the one rail to a location on the combine component.

The method may further comprise: attaching the collection pan to the retention system; and slidably receiving the at least one rail in a corresponding at least one rail channel of a plurality of rail channels on a bottom surface of the receptacle portion.

Attaching the collection pan to the retention system may comprise: attaching the receptacle portion to a receptacle retaining component of the retention system, wherein the receptacle retaining component may be configured to retain and release the receptacle portion in response to a wireless signal from a controller; and attaching the cover portion to a cover retaining component of the retention system, wherein the cover retaining component may be configured to retain the cover portion independently of the receptacle retaining component.

The method may further comprise: separating the usable portions in the sample from the unusable portions in the sample using a screening component of the receptacle portion; and folding the receptacle portion along at least one fold line to change a shape of a bottom surface of a receiving component of the receptacle portion to facilitate transfer of the usable portions in the sample to a mobile gauge system.

In another embodiment, there is provided a collection pan for use in combination with a combine harvester operable to cut a crop to be harvested, separate usable portions of the crop from unusable portions of the crop, and discharge material comprising both the usable portions and the unusable portions, the collection pan configured to be slidably received on at least one rail mounted to a combine component of the combine harvester. The collection pan comprises: a receptacle portion for receiving a sample of the material discharged from the combine harvester, and configured to be coupled to a retention system; and a cover portion for covering the receptacle portion and configured to be coupled to the retention system. The cover portion covers the receptacle portion when the retention system retains both the cover portion and the receptacle portion. The receptacle portion slides along the at least one rail and the cover portion is separated from the receptacle portion to allow the receptacle portion to receive the sample when the retention system retains the cover portion and releases the receptacle portion.

Other aspects and features of the present disclosure will become apparent to those ordinarily skilled in the art upon review of the following description of specific embodiments of the disclosure in conjunction with the accompanying figures.

### BRIEF DESCRIPTION OF DRAWINGS

Reference will now be made, by way of example, to the accompanying drawings, which show example embodiments of the present application, and in which:

FIGS. 1A and 1B are perspective views of a loss measurement system in accordance with one embodiment, where the loss measurement system is mounted to a combine harvester and a retention system of the loss measurement system is in, respectively, a retain mode and a partial release mode;

FIGS. 2A and 2B are exploded perspective views of the loss measurement system of FIG. 1A in accordance with different embodiments;

FIG. 3A is a side elevation view of a second rail of the loss measurement system of FIG. 2A in accordance with one embodiment;

FIG. 3B is a side elevation view of a single rail of the loss measurement system of FIG. 2B in accordance with one embodiment;

FIG. 4 is a perspective view of a first rail and the second rail of the loss measurement system of FIG. 2A in accordance with one embodiment;

FIGS. 5A and 5B are, respectively, a top plan view and a bottom plan view of a receptacle portion of a collection pan of the loss measurement system of FIG. 2A in accordance with one embodiment;

FIG. 5C is a bottom plan view of a receptacle portion of a collection pan of the loss measurement system of FIG. 2B in accordance with one embodiment;

FIG. 6A is a top view of a cover portion of the collection pan of the loss measurement system of FIG. 2A in accordance with one embodiment;

FIG. 6B is a top view of a cover portion of the collection pan of the loss measurement system of FIG. 2B in accordance with one embodiment;

FIG. 7 is a perspective view of the receptacle and cover portions of the collection pan of the loss measurement system of FIG. 2A in a storage configuration;

FIGS. 8A and 8B are side elevation views of the second rail and the retention system of the loss measurement system of FIG. 2A in accordance with one embodiment, where the retention system is in, respectively, the retain mode and the partial release mode;

FIG. 9 is an enlarged top view of the second rail, the cover portion, and the receptacle portion, and the retention system of the loss measurement system of FIG. 2A in accordance with one embodiment, where the retention system is in the retain mode;

FIG. 10 is a top plan view of the mobile gauge system of the loss measurement system of FIG. 2A in accordance with one embodiment; and

FIG. 11 is a schematic of a method of measuring loss based on using the loss measurement system of FIGS. 2A and 2B to measure a sample of the material discharged from the combine harvester in accordance with one embodiment.

### DETAILED DESCRIPTION

For the purposes of this disclosure, the expressions “usable portions,” “grain,” and “usable grain” are intended to designate any usable portion of a crop that is harvested by a combine harvester. As described below, different combine harvesters may be configured to harvest a variety of different types of crops, such as wheat, bulgur, millet, amaranth, barley, oat, rye, soybeans, sunflower, corn, etc. Accordingly, the “usable portion” includes without limitation, actual grains (e.g., barley and wheat), seeds (e.g., sunflower), nuts, beans, cobs, etc. In contrast, the expressions “unusable portions,” “straw” and “chaff” are intended to designate any unusable portion of the crop that is harvested by the combine harvester. Depending on the type of crop being harvested by the combine harvester, the “unusable portions” include without limitation, stems, leaves, seed casings, hulls, glumes, straw, chaff, etc. Generally, the usable and unusable portions of a crop are mutually exclusive.

For the purpose of this disclosure, the expression “discharged material” or “material discharged” by a residue management unit of a combine harvester is intended to designate any material which is discharged by the combine harvester back to the ground at a field location. A sample of this discharged material is collected on a collection pan of a loss measurement system as described below. The discharged material generally includes a combination of the usable and unusable portions of the crop.

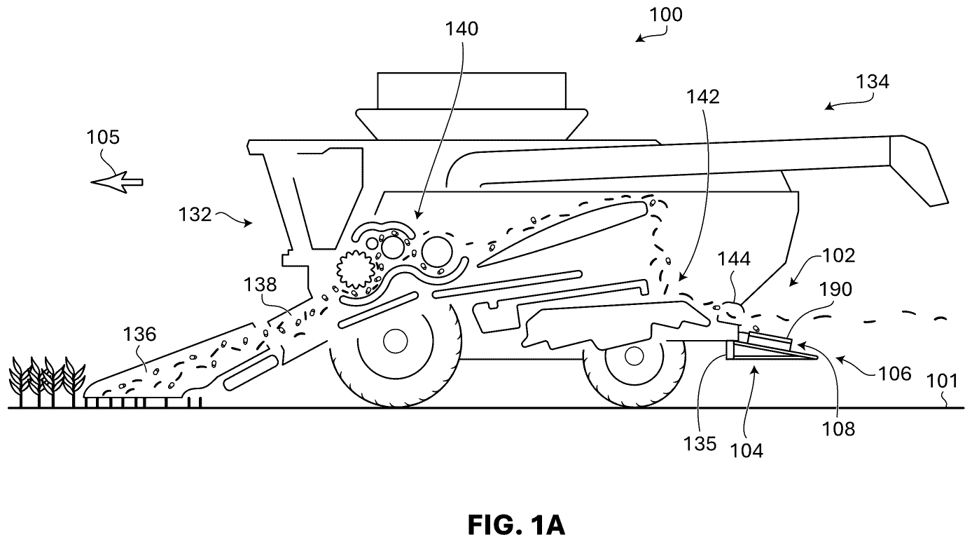

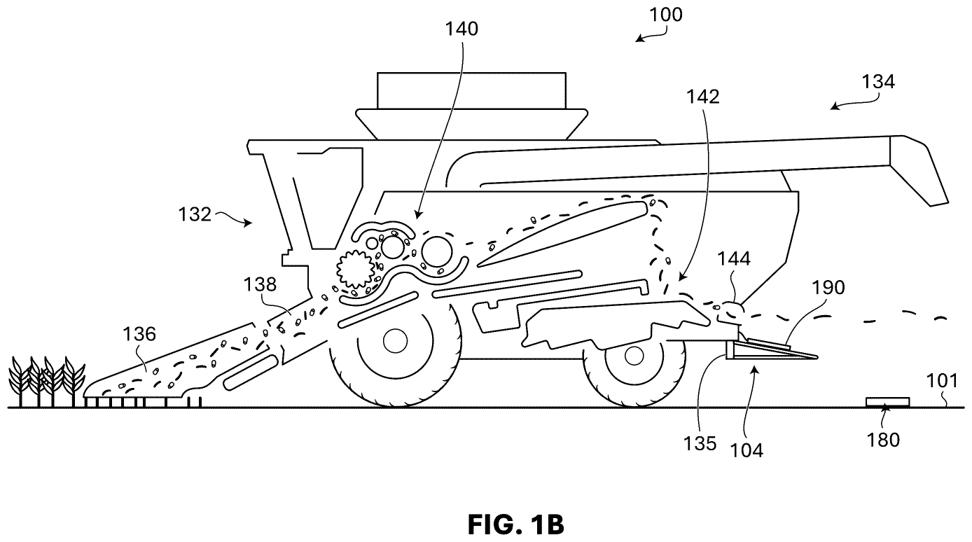

Referring to FIGS. 1A and 1B, there is illustrated a combine harvester 100 having a loss measurement system 102 mounted thereto. The combine harvester 100 is used to harvest crop growing from the ground 101 over which the combine harvester 100 is traveling. The crop may be, for example, wheat, barley, oat, rye, soybeans, canola, flax, sunflower, corn, etc. Those skilled in the art will appreciate that other combine harvesters 100 may harvest a large variety of different types of crops.

Referring now to FIG. 1A, the combine harvester 100 includes a vehicle body 130 supported on wheels and which allow the vehicle body 130 to move over the ground 101 in a direction of travel 105 at a field location 103 where the crop is planted. A header 136 is coupled to a front portion 132 of the vehicle body 130. The header 136 includes an implement for cutting the crop as the combine harvester 100 is moved over the ground 101. The implement may be selected depending on the type of crop to be harvested by the combine harvester 100 and may include grain headers, corn headers, sunflower headers, etc. The crop harvested by the implement is guided internally through the vehicle body 130 to a feederhouse 138 and then to a threshing unit 140. The threshing unit 140 generally functions to remove usable portions of the crop (e.g., grain, seed, nut, kernel, cob or bean) from unusable portions of the crop (e.g., straw or chaff). The threshing unit 140 then directs the remaining crop to a shoe 142, where chaffer and sieves further separate the usable portions from the unusable portions. The unusable portions are then discharged from the vehicle body 130 via a residue management unit 144 positioned at a rear portion 134 of the vehicle body 130. The residue management unit 144 may include a fan that blows the discharged material away from the vehicle body 130 in a direction opposite the direction of travel 105 of the combine harvester 100. The usable portion is generally collected at the bottom of a grain elevator (not shown) which lifts the usable portion upwards to an augur (not shown) to discharge the usable portion into a hopper (not shown).

However, the residue management unit 144 may sometimes also undesirably discharge some of the usable portions of the crop. The amount of the usable portions in the material discharged by the residue management unit 144 may depend on operational parameters of the combine harvester 100, potentially in combination with the condition of the crop on the ground 101 (e.g., moisture content) and weather at the field location 103 (e.g., humidity). For example, a fan speed and sieve opening size of the residue management unit 144, a speed of travel of the combine harvester 100, a concave distance and a rotation speed of the threshing unit 140, and a height of the header 136 relative to a height of the crop, are all operational parameters which can be adjusted to reduce or otherwise manage loss of the usable portions (e.g., grains, seeds, nuts, etc.) of the crop. Further, a same operational parameter may result in different amounts of the usable portions being included in the discharged material depending on different conditions of the crop on the ground 101 and different types of weather at the field location 103. For example, a particular fan speed may result in an increased amount of the usable portions in the discharged material when the weather is dry versus when the weather is more humid. As weather and crop conditions may change every day, it may be necessary for an operator of the combine harvester 100 to assess usable portion loss on a daily basis to reduce loss of profits.

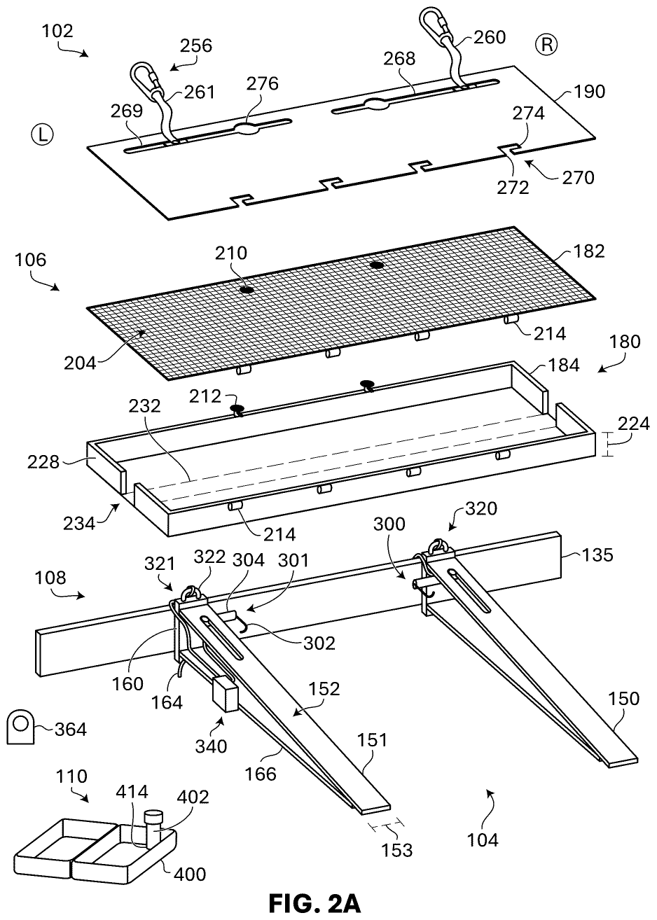

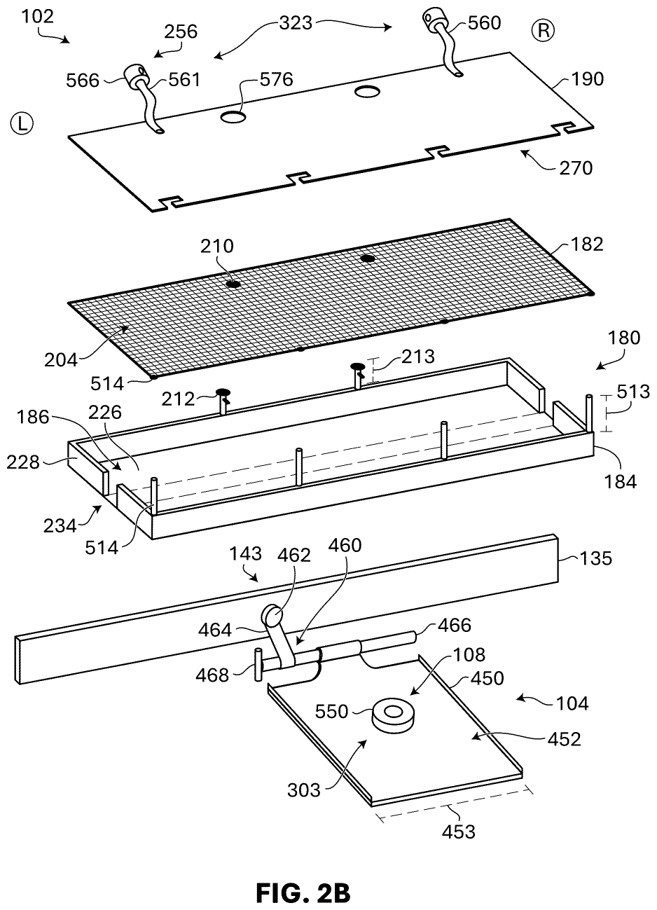

The loss measurement system 102 can be used to assess how much of the usable portions is being inadvertently included in the material being discharged by the residue management unit 144. Referring briefly to FIG. 2A, the loss measurement system 102 includes: (A) at least one rail 104 configured to mount other components of the loss measurement system 102 to a combine structure 135 on the rear portion 134 of the combine harvester 100, (B) a collection pan 106 configured to be slidably received on the at least one rail 104 and comprising a receptacle portion 180 and a cover portion 190, and (C) a retention system 108 configured to switch between at least a retaining mode in which both the receptacle and cover portions 180 and 190 of the collection pan 106 are retained on the at least one rail 104 (shown in FIG. 1A) and a partial release mode in which the cover portion 190 is retained on the at least one rail 104 but the receptacle portion 180 is released (shown in FIG. 1B). In some embodiments, the loss measurement system 102 may also include a mobile gauge system 110 comprising a carrying case 400 and a calibrated container 402 which allows the operator to estimate an amount of usable portion or grain loss while at the field location 103. Each of these components will now be described in detail in turn.

### At Least One Rail 104

Referring now to FIGS. 2A, 2B, 3A, 3B, and 4, the loss measurement system 102 may include the at least one rail 104 for mounting other components of the loss measurement system 102 to the combine structure 135 on the rear portion 134 of the combine harvester 100.

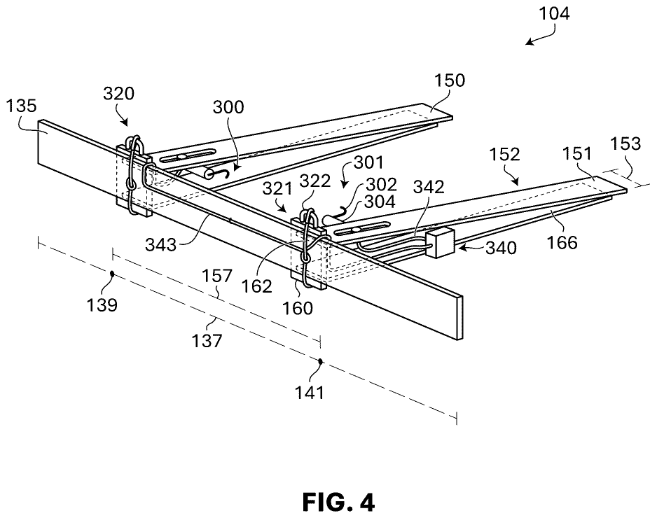

In the embodiment shown in FIGS. 2A, 3A and 4, the at least one rail 104 comprises at least two rails (a first rail 150 and a second rail 151 are shown in FIGS. 2A and 4, although those skilled in the art will appreciate that alternative embodiments may include three rails, four rails, five rails, etc.) which may be mounted to the combine structure 135 at a location along a length 137 of the combine structure 135 independently of each other. For example, referring to FIG. 4, the first rail 150 may be mounted at a first location 139 along the length 137 of the combine structure 135, while the second rail 151 may be mounted at a second location 141 (independently of the first location 139) along the length 137, such that there is a separation distance 157 between the first and second rails 150 and 151. The ability to mount the first and second rails 150 and 151 independently of each other (e.g., change the first and second locations 139 and 141 and/or the separation distance 157) allows the loss measurement system 102 to be mounted to combine structures 135 of combine harvesters 100 which may have differing lengths 137. Further, the ability to mount the first and second rails 150 and 151 independently of each other also allows the loss measurement system 102 to be attached to combine structures 135 which have non-uniform features, such as protrusions, attachments, recesses, etc., as the first and second rails 150 and 151 may be independently mounted to avoid such features.

In other embodiments, additional rails 104 (e.g., such as the third rail or fourth rail (not shown)) may be added to further support the other components of the loss measurement system 102 for particularly large combine harvesters 100. Such additional rails 104 may, again, be mounted at any location along the length 137 of the combine structure 135 independently from the first and second rails 150 and 151. In some other embodiments, the at least one rail 104 may only include a single rail (not shown), which may be the only rail required to support the other components of the loss measurement system 102 for particularly small combine harvesters 100.

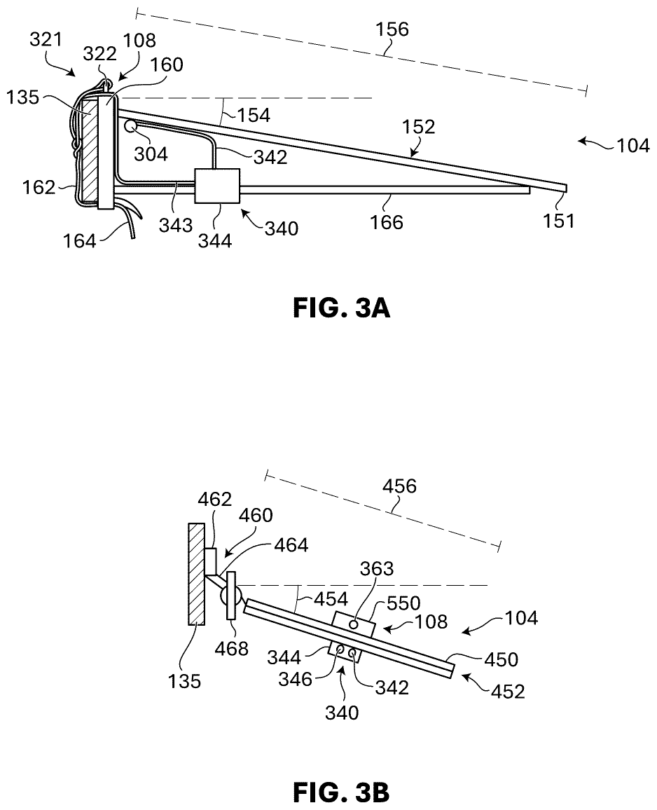

In the embodiment shown in FIGS. 2B and 3B, the at least one rail may comprise single rail 450. The single rail 450 may be mounted to the combine structure 135 at a selected location 143 along the length 137 of the combine structure 135 independently of any additional components. The ability to mount the single rail 450 at a single selected location 143 along the combine structure 135 also allows the loss-measurement system to be used with combine harvesters 100 having non-linear geometries or having non-uniform features, such as protrusions, attachments, or recesses, since the single rail 450 may be positioned to avoid such features.

### Mounting Component 160 and 460

Referring to FIGS. 3A and 4, to facilitate the independent mounting described above for the first and second rails 150 and 151, each of the first and second rails 150 and 151 includes a respective mounting component 160. For clarity, only the mounting component 160 associated with the second rail 151 will be described below; those skilled in the art will appreciate that the corresponding mounting component 160 associated with the first rail 150 (or with any other additional rails 104) may be configured in a similar manner. The mounting component 160 is generally configured to allow the second rail 151 to be removably mounted to combine structures 135 of varying different shapes and sizes, and may comprise one or a combination of binding-based mounting components (e.g., cables or other flexible bindings), magnetic-based mounting components, and vacuum-suction-based mounting components.

In the embodiment shown in FIGS. 3A and 4, the mounting component 160 comprises a flexible cable 162 and a cable tightener 164 (best shown in FIG. 3A). The cable 162 may be attached to the second rail 151 at a first end, may be looped over the combine structure 135, may be looped through the cable tightener 164 and attached to the second rail 151 at a second end. The cable tightener 164 may then be actuated to tighten the cable 162 around the combine structure 135 to mount the second rail 151 at the second location 141. The precise type and position of the cable tightener 164, and variations therein, will become apparent to those skilled in the art, particularly when considering the purpose of the cable tightener 164 for tightening the second rail 151 to the combine structure 135. Those skilled in the art will also appreciate that using the flexible cable 162 allows the second rail 151 to be mounted to different combine structures 135 having a variety of different shapes, including combine structures 135 having, for example, a circular cross-section, a triangular cross-section, a square or rectangular cross-section, a polygonal cross-section, or a non-uniform cross-section. In other embodiments, the mounting component 160 may comprise a magnet, or a vacuum-suction device, or any other fastener that allows the second rail 151 to be mounted at the second location 141. Generally, the mounting component 160 comprising the magnet or the vacuum-suction device may be better adapted for use with combine structures 135 having a substantially flat surface and/or a substantially even surface, such as a combine structure 135 comprising a square or rectangular cross-section for example. In some embodiments, the mounting component 160 may comprise the binding-based mount in combination with one or more of the magnetic-based mount and the suction-based mount.

Further, those skilled in the art will also appreciate that different combine harvesters 100 from different manufacturers may have a significant variation in shape and dimension of the combine structures 135 available at the rear portion 134 of the vehicle body 130 to which the first and second rails 150 and 151 can be mounted. For example, combine harvesters 100 from John Deere® may have a combine structure 135 having a substantially rectangular or square cross-section, whereas combine harvesters 100 from CLAAS® may instead include a combine structure 135 having a polygonal or circular cross-section.

Referring to FIGS. 2B and 3B, to facilitate the mounting described above for the single rail 450, the single rail 450 includes a corresponding mounting component 460. The mounting component 460 is generally configured to allow the single rail 450 to be removably mounted to combine structures 135 of varying shapes and sizes, and may comprise one or a combination of binding-based mounting components (e.g., cables or other flexible bindings) similar to the mounting component 160 described above, magnetic-based mounting components (e.g., at least one magnet 462 described in greater detail below), and vacuum-suction-based mounting components. The mounting component 460 generally allows the single rail 450 to be secured regardless of the geometry of the combine structure 135.

In the embodiment shown in FIGS. 2B and 3B, the mounting component 460 comprises at least one magnet 462 (only one is shown in FIG. 2B), a post 464, a rod 466, and an adjuster 468. The at least one magnet 462 is secured to a first end of the post 464 and is generally configured to secure the single rail 450 to the combine structure 135 at the selected location 143 and extends the single rail 450 slightly away from the combine structure 135 to allow the mounting component 460 to be mounted to the combine structure 135 with the at least one magnet 462 alone. The combination of the at least one magnet 462 and the extending post 464 generally allows the single rail 450 to be mounted to combine structures 135 having various different geometries, as the primary attachment point between the single rail 450 and the combine structure 135 is the smaller at least one magnet 462 (relative to the width 453 or the length 456 of the sliding component 452); while the larger structure of the sliding component 452 of the single rail 450 is extended away from the combine structure 135 via the post 464. In some embodiments, the at least one magnet 462 comprises an electromagnet configured to be magnetized and demagnetized in response to ceasing to receive an electric current. The rod 466 is secured to a second end of the post 464 and carries the sliding component 452 of the single rail 450. The adjuster 468 is coupled to the rod 466 and is operable to adjust an angle 454 of the single rail 450 relative to the ground 101, and may comprise a friction hinge, an indexed hinge, a locking hinge (e.g., cam lever or threaded knob) etc. In other embodiments, the mounting component 460 may comprise a flexible binding mechanism and an associated device in a manner similar to the mounting component 160 described above, a vacuum-suction device, or any other fastener that generally allows the single rail 450 to be removably mounted to the selected location 143.

In combination, (A) the ability to mount different rails 150, 151 and 450 of the at least one rail 104 to different locations along the length 137 of the combine structure 135 independently of each other, and (B) the flexible mounting component 160 associated with each rail 150 and 151 or the small footprint mounting component 460 associated with the single rail 450 provides the at least one rail 104 with (1) the ability to mount to combine harvesters 100 of different sizes, (2) the ability to mount to different combine structures 135 having different shapes and dimensions, and (3) interchangeably use a same particular loss measurement system 102, or reuse certain components of a particular loss measurement system 102 (e.g., one or both of the first and second rails 150 and 151) with a variety of different combine harvesters 100.

More specifically, those skilled in the art will appreciate that combine harvesters 100 come in a large variety of different sizes. For example, combine harvesters 100 from John Deere® alone include models which range between 8 feet and 17 feet. The ability to independently mount different rails 150 and 151 allows the loss measurement system 102 to be used with combine harvesters 100 of different sizes. For example, on a smaller combine harvester 100, the separation distance 157 between the first and second rails 150 and 151 may be at most approximately 6 feet apart, and may be approximately 5.25, 5.0, 4.75, 4.5, 4.25, 4.0, 3.75, 3.5, 3.25, 3.0, 2.75, 2.5, 2.25, 2.0, 1.75, 1.7, 1.66, 1.5, 1.25, etc. feet apart; in contrast, on a larger combine harvester 100, the separation distance 157 between the first and second rails 150 and 151 may be at least 4 feet apart, such as 4.25, 4.5, 4.75, 5.0, 5.25, 5.5, 5.75, 6.0 etc. feet apart. Further, as mentioned above, for some smaller combine harvesters 100, the at least one rail 104 may only include the single rail 450. In such embodiments, the single rail may generally be positioned at a middle of a width 222 of the receiving component 184 of the receptacle portion 180, and may specifically be received in one of a set of central rail channels 236I, 236J, 236K, 536A of the receiving component 184 (described below).

### Sliding Component 152 and 452

Still referring to FIGS. 2A, 3A and 4, each of the first and second rails 150 and 151 further includes a sliding component 152 which is generally configured to receive the collection pan 106 as described below. Again, for clarity, only the sliding component 152 of the second rail 151 will be described below; those skilled in the art will appreciate that the corresponding sliding component 152 of the first rail 150 (or of any other rails 104) may be configured in a similar manner. Generally, the sliding component 152 is configured, shaped and dimensioned to (A) support the collection pan 106 during operation of the combine harvester 100 while the retention system 108 is in the retain mode and (B) guide the receptacle portion 180 of the collection pan 106 to an appropriate position and upwards configuration on the ground 101 during operation of the combine harvester 100 after the retention system 108 switches to the partial release mode and releases the receptacle portion 180 (shown in FIG. 1B).

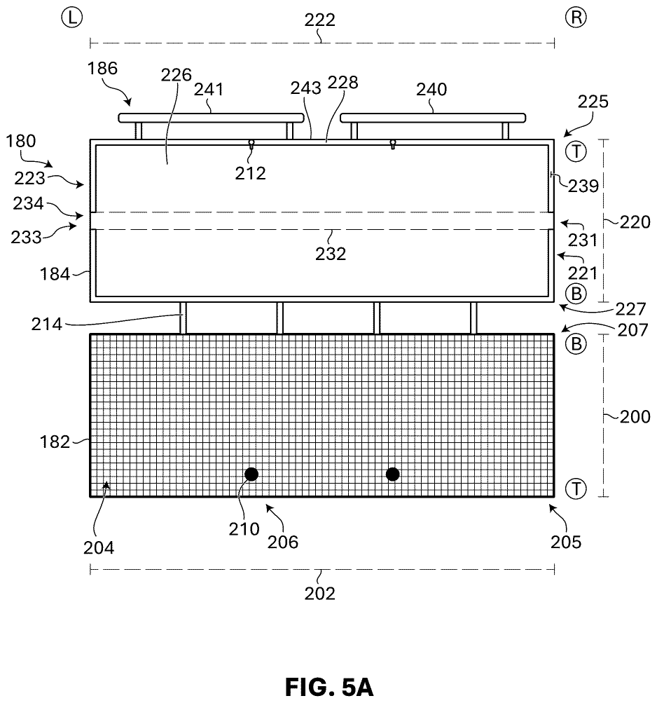

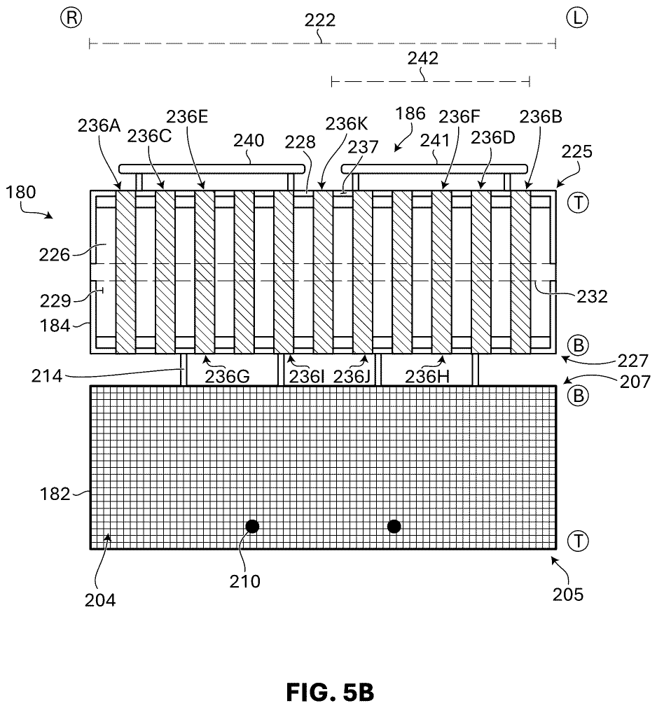

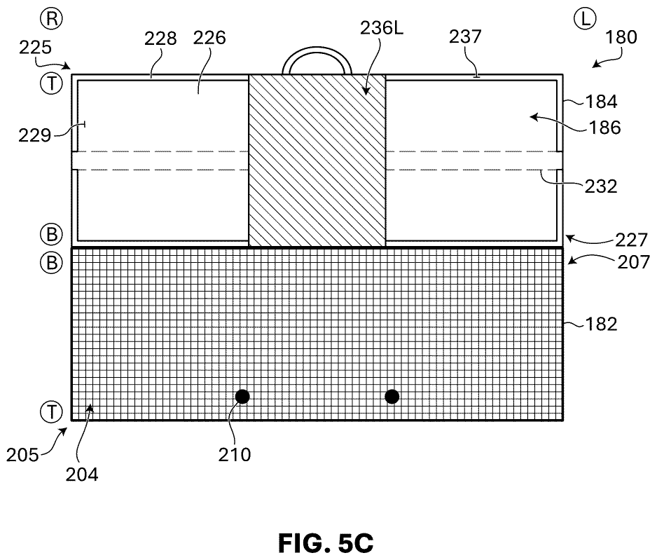

Accordingly, referring specifically to FIGS. 2A and 4, the sliding component 152 of the second rail 151 has a width 153 which allows the second rail 151 (in combination with the first rail 150) to support the collection pan 106 when the retention system 108 is in the retain mode. In the embodiment shown, the width 153 is approximately 2 inches; however, in other embodiments, the width 153 may range between approximately 0.5 inches and approximately 12.5 inches. For example, in embodiments where the second rail 151 comprises the single rail supporting other components of the loss measurement system 102, the width 153 may be wider (e.g., at least 2 inches); in contrast, where the second rail 151 is one of more than two rails, the width 153 may be correspondingly narrower (e.g., at most 3 inches). Generally, the loss measurement system 102 is configured such that the width 222 of the receiving component 184 of the receptacle portion 180 (which receives the at least one rail 104) is significantly larger than the width 153 of the second rail 151. For example, in the embodiment shown in FIG. 2A, the width 153 of the first and second rails 150 and 151 is approximately 2 inches, while the width 222 of the receiving component 184 (shown in FIG. 5B) is approximately 66 inches. Having smaller first and second rails 150 and 151 may allow these rails 150 and 151 to be mounted to the combine structure 135 with greater ease and modularity. Further, in the embodiment shown, the widths 153 of the first and second rails 150 and 151 are the same. However, in other embodiments, the widths 153 of different first and second rails 150 and 151 (or any other rail 104) of a particular loss measurement system 102 may be different from each other, and may be varied based on the type of combine harvester 100 and/or the size and dimension of the combine structure 135 to which the corresponding rail 104 is to be mounted. For example, in embodiments where the combine structure 135 is oddly shaped or oddly sized, the corresponding rail 104 mounted thereto may have a smaller width 153 in order to be securely and stably mounted.

Referring now to FIG. 3A, the sliding component 152 may be mounted to the combine structure 135 such that the sliding component 152 is at an angle 154 relative to the ground 101 over which the combine harvester 100 travels. Generally, the angles 154 of the first and second rails 150 and 151 are the same to stably support the collection pan 106. The angle 154 ensures that, after the retention system 108 switches to the partial release mode, the receptacle portion 180 of the collection pan 106 slides off the first and second rails 150 and 151 and lands at an appropriate location behind the vehicle body 130 and in the upwards configuration on the ground 101. Generally, the angle 154 is an acute angle that is less than 90°. This allows the receptacle portion 180 to slide more gently off the first and second rails 150 and 151 and to land more softly on the ground 101 when compared to existing drop pan systems with a substantially vertical drop. This may reduce the likelihood that the collection pan 106 will flip over or land askew when it contacts the ground 101, particularly when the combine harvester 100 is moving relatively quickly. Additionally, this also allows the receptacle portion 180 to land slightly further behind the vehicle body 130 when compared to existing drop pan systems with the substantially vertical drop. This may reduce a volume of the sample of the material discharged by the residue management unit 144 and collected on the receptacle portion 180, particularly when the combine harvester 100 is moving slowly. Those skilled in the art will appreciate that steeper angles 154 may allow the sliding component 152 to guide the collection pan 106 closer to the ground 101 and also closer to the vehicle body 130. In contrast, those skilled in the art will appreciate that shallower angles 154 may allow the sliding component 152 to drop the collection pan 106 from further above the ground 101, but further also from the vehicle body 130. In the embodiment shown, the angle 154 is approximately 28°; however, in other embodiments, the angle 154 may range between approximately 20° and approximately 40°.

Still referring to FIG. 3A, the sliding component 152 may have a length 156. The length 156 allows the sliding component 152 to guide the collection pan 106 towards the ground 101 more gently, and to deposit the collection pan 106 further away from the vehicle body 130, particularly when compared to existing drop pan systems having a substantially vertical drop. In the embodiment shown, the length 156 is approximately 30.5 inches; however, in other embodiments, the length 156 may range between approximately 22 inches and approximately 30.5 inches. As will be appreciated by one of ordinary skill in the art, longer lengths 156 may guide the collection pan 106 closer to the ground 101 and/or further behind the vehicle body 130 (depending on the angle 154). In contrast, shorter lengths 156 may drop the collection pan 106 further away from the ground and/or closer behind the vehicle body 130 (again depending on the angle 154).

Referring now to FIGS. 2B and 3B, the single rail 450 correspondingly includes the sliding component 452 generally configured to receive the collection pan 106. Similar to the sliding component 152 described above, the sliding component 452 is configured, shaped and dimensioned to (A) support the collection pan 106 during operation of the combine harvester 100 while the retention system 108 is in the retain mode and (B) guide the receptacle portion 180 of the collection pan 106 to an appropriate position and upwards configuration on the ground 101 during operation of the combine harvester 100 after the retention system 108 switches to the partial release mode and releases the receptacle portion 180 (shown in FIG. 1B).

Referring specifically to FIG. 2B, the sliding component 452 has a width 453 that allows the single rail 450 to independently support the collection pan 106 when the retention system 108 is in the retain mode. In the embodiment shown, the width 453 is approximately 15 inches; however, in other embodiments, the width 453 may range between approximately 5 inches and approximately 45 inches. The width 222 of the receiving component 184 of the receptacle portion 180 (which receives the at least one rail 104) is again significantly larger than the width 453 of the single rail 450.

Referring now to FIG. 3B, and as described briefly above, the mounting component 460 allows the sliding component 452 to be mounted to the combine structure 135 such that the sliding component 452 is at an angle 454 relative to the ground 101 over which the combine harvester 100 travels. The angle 454 is similar to the angle 154 described above and generally ensures that, after the retention system 108 switches to the partial release mode, the receptacle portion 180 of the collection pan 106 slides off the single rail 450 and lands at an appropriate location behind the vehicle body 130 and in the upwards configuration on the ground 101. Generally, the angle 454 is also an acute angle less than 90°. Again, this allows the receptacle portion 180 to slide more gently off the single rail 450 and to land more softly on the ground 101 when compared to existing drop pan systems with a substantially vertical drop, which may reduce the likelihood that the collection pan 106 will flip over or land askew when it contacts the ground 101. Additionally, this also allows the receptacle portion 180 to land slightly further behind the vehicle body 130 when compared to existing drop pan systems with the substantially vertical drop, which may reduce a volume of the sample of the material discharged by the residue management unit 144 and collected on the receptacle portion 180. In the embodiment shown, the angle 454 is approximately 28°; however, in other embodiments, the angle 454 may range between approximately 20° and approximately 40°.

Still referring to FIG. 3B, the sliding component 452 also has a length 456. The length 456 is similar to the length 156 and allows the sliding component 452 to guide the collection pan 106 towards the ground 101 more gently, and to deposit the collection pan 106 further away from the vehicle body 130, particularly when compared to existing drop pan systems having a substantially vertical drop. In the embodiment shown, the length 456 is approximately 15-16 inches; however, in other embodiments, the length 456 may range between approximately 5 inches and approximately 50 inches. Further, in the embodiment shown in FIGS. 2B and 3B, the width 453 and the length 456 are similar (and may have a difference between 5%-20%). As such, the sliding component 452 has a slightly square configuration. Having a slightly square configuration may provide the sliding component 452 with a broader and more stable bearing surface for the receptacle portion 180 when the single rail 450 is the only support for the receptacle portion 180. This can allow the receptacle portion 180 to slide smoothly and predictably rather than tipping, bouncing or free-falling when compared to existing drop pan systems having a substantially vertical drop.

In some embodiments (not shown), the at least one rail 104 may be configured such that the angle 154 or 454 may be adjusted. For example, the sliding component 152 or 452 may be coupled to a ratchet system or a hydraulic system to allow adjustment of the angle 154 or 454. As described above, the adjuster 468 of the mounting component 460 of a single rail 450 may specifically perform this function. The operator may adjust the angle 154 or 454 based on one or more of: a dimension of the collection pan 106, a speed of travel of the combine harvester 100, a current crop type at the field location 103, a maturity of the crop, weather, etc. For example, in situations (or at field locations 103) where the combine harvester 100 is travelling at a higher speed, the angle 154 or 454 may be steeper (e.g., larger) in order to deposit the collection pan 106 onto the ground 101 close to the vehicle body 130 and sufficiently in front of the residue management unit 144 for the collection pan 106 to receive the discharged material from the residue management unit 144. In contrast, in situations (or for field locations 103) where the combine harvester 100 is travelling at a lower speed, the angle 154 or 454 may be shallower (e.g., smaller) in order to deposit the collection pan 106 onto the ground 101 further away from the vehicle body 130 and so that the collection pan 106 does not receive too much material discharged from the residue management unit 144. Further, in situations where the collection pan 106 is relatively large and heavy, the angle 154 or 454 may be steeper as the weight of the collection pan 106 may enable the collection pan 106 to land in the upwards configuration even if rapidly and vertically dropped. In contrast, in situations where the collection pan 106 is smaller and lighter, the angle 154 or 454 may be shallower to more gently deposit the collection pan 106 onto the ground 101, to ensure that the collection pan 106 lands in the upwards configuration. The specific applicable angle 154 or 454, and variations therein, will become apparent to those skilled in the art, particularly when considering the interactions between the movement of the combine harvester 100 and a weight of the collection pan 106 and the purpose of the angle 154 or 454 for depositing the collection pan 106 in the upwards configuration and an appropriate distance behind the vehicle body 130.

In some embodiments (not shown), the at least one rail 104 may also be configured such that the length 156 or 456 may be adjusted. For example, the sliding component 152 or 452 may have one or more telescopic features or portions that may be removably attached. The operator may adjust the length 156 or 456 based on one or more of: a dimension of the collection pan 106, a speed of travel of the combine harvester 100, a current crop type at the field location 103, a maturity of the crop, weather, etc. For example, in situations where the combine harvester 100 is travelling at a higher speed, the length 156 or 456 may be shorter in order to deposit the collection pan 106 onto the ground 101 closer to the vehicle body 130 for reasons similar to those described above; whereas in situations where the combine harvester 100 is travelling at a lower speed, the length 156 or 456 may be longer in order to deposit the collection pan 106 onto the ground 101 further away from the vehicle body 130. The specific applicable length 156 or 456, and variations therein, will become apparent to those skilled in the art, particularly when considering the interactions between the movement of the combine harvester 100 and the weight of the collection pan 106 and the purpose of the length 156 or 456 for depositing the collection pan 106 in the upwards configuration and an appropriate distance behind the vehicle body 130.

### Support Component 166

Referring to FIGS. 2A and 3B, each of the first and second rails 150 and 151 further includes a support component 166. Again, for clarity, only the support component 166 of the second rail 151 will be described below; those skilled in the art will appreciate that the corresponding support component 166 of the first rail 150 (or of any other rails 104) may be configured in a similar manner. Generally, the support component 166 is configured, shaped and dimensioned to (A) support the sliding component 152 at the angle 154 and (B) further support the collection pan 106 during operation of the combine harvester 100 while the retention system 108 is in the retain mode. However, some embodiments of the second rail 151 may not include the support component 166 and may only include the sliding component 152 and the mounting component 160. In yet other embodiments (not shown), the second rail 151 may include more than one support component 166. For example, the single rail 450 shown in FIGS. 2B and 3B does not include a corresponding support component 166, and is instead mounted to the combine structure 135 via the mounting component 460 alone.

In the embodiment shown, the support component 166 is coupled to the sliding component 152 at a first end and to the mounting component 160 at a second end, such that the second rail 151 has a substantially triangular side profile (best shown in FIG. 3A). The support component 166 may have a width that is substantially similar to the width 153 of the sliding component 152 and a length that allows the support component 166 to be coupled to both the sliding component 152 and the mounting component 160. However, in other embodiments, the support component may have any shape or dimension that allows the support component 166 to perform the (A) and (B) functions noted above.

In the embodiment shown, the various sliding, mounting and support components 152, 452, 160, 460, 166 of the first and second rails 150 or 151 and the single rail 450 are made of aluminum or aluminum alloy, and may specifically be made of 1100 aluminum or a 3003 aluminum alloy. In other embodiments, the various sliding, mounting and support components 152, 452, 160, 460, 166 may be made of a different metal or metal alloy, and may be made of at least one of steel, brass, bronze, zinc or nickel. In yet other embodiments, the various sliding, mounting and support components 152, 452, 160, 460, 166 may be made of other rigid or inelastic materials, such as wood, inelastic polymers (e.g., inelastic plastic or carbon fiber), etc.

### Collection Pan 106

Referring now to FIGS. 2A, 2B, 5A, 5B, 5C, 6A, 6B and 7, the collection pan 106 including the receptacle portion 180 and the cover portion 190 will now be described. The collection pan 106 is configured to be slidably received on the at least one rail 104. Both the receptacle portion 180 and the cover portion 190 are configured to be retained on the at least one rail 104 when the retention system 108 is in the retain mode (shown in FIG. 1A). When both the receptacle portion 180 and the cover portion 190 are retained on the at least one rail 104, the cover portion 190 covers the receptacle portion 180 and prevents the receptacle portion 180 from receiving any of the usable or unusable portions of the crop. In this regard, while the collection pan 106 is retained on the at least one rail 104, material that may come into contact with the collection pan 106 (and which may fall into the receptacle portion 180 if it were not covered by the cover portion 190) may be any excess or loose material from operation of the combine harvester 100, rather than the material that is discharged by the residue management unit 144. Such excess or loose material may fill the receptacle portion 180 prior to its deposit onto the ground 101 away from the vehicle body 130, which may affect the ability of the receptacle portion 180 to function as an accurate gauge for the usable portions in the sample of the material discharged by the residue management unit 144. In contrast, when the retention system is in the partial release mode (shown in FIG. 1B), the cover portion 190 is retained on the at least one rail 104 while the receptacle portion 180 is released and slides down the sliding component 152 of the at least one rail 104 (e.g., due to the angle 154), until it separates from the at least one rail 104 and is deposited onto the ground 101. Separation of the cover portion 190 from the receptacle portion 180 exposes a screening component 182 and a receiving component 184 of the receptacle portion 180, and allows the screening and receiving components 182 and 184 to receive the sample of the material discharged by the residue management unit 144. The different portions 180 and 190 will now be described below.

### Receptacle Portion 180

The receptacle portion 180 is generally configured to be deposited on the ground 101 at the field location 103 and to receive the sample of the material discharged by the residue management unit 144. Referring now specifically to FIGS. 2A, 2B, 5A, 5B, and 5C, the receptacle portion 180 includes the screening component 182, the receiving component 184 and the retaining component 186. The retaining component 186 is configured to interact with the retention system 108 to retain the receptacle portion 180 on the at least one rail 104 when in the retain mode (shown in FIG. 1A) and to release the receptacle portion 180 from the at least one rail 104 when in the partial release mode (shown in FIG. 1B). In operation, when the retention system 108 switches to the partial release mode, the release of the retaining component 186 causes the receptacle portion 180 to slide along the at least one rail 104 before being deposited on the ground 101. The screening component 182 is configured to be positioned on top of the receiving component 184 when the receptacle portion 180 is deposited on the ground 101 in the upwards configuration. The screening component 182 generally functions as a screen, sieve or filter, which can be used to initially remove larger unusable portions (e.g., chaff, straw, etc.) from the smaller unusable portions (e.g., glumes, seed casings, hulls, etc.) and the usable portions (e.g., grain, seed, etc.) of the sample of the discharged material received on the receptacle portion 180 as the operator manually agitates or rustles the sample lying on top of the screening component 182. The receiving component 184 then receives both the remaining smaller unusable portions together with the smaller usable portions in the sample. The operator can then partially detach the screening component 182 from the receiving component 184 and further manually remove the unusable portions in the receiving component 184. The usable portions then remaining in the receiving component 184 may be transferred to the calibrated container 402 of the mobile gauge system 110, which allows the operator to estimate the amount of usable portion loss while remaining at the field location 103. The different components 182, 184 and 186 will now be described below.

### Screening Component 182

Referring to FIG. 5A, the screening component 182 has a length 200 extending between a top end 205 and a bottom end 207, and a width 202 extending between a left end and a right end. In the embodiment shown, the length 200 is approximately 66 inches, while the width 202 is approximately 12 inches; however, in other embodiments, the length 200 may range between approximately 24 inches and approximately 70 inches, while the width 202 may range between approximately 10 inches and approximately 24 inches. In some embodiments, one or both of the length 200 and the width 202 of the screening component 182 may be slightly (approximately 0.1 to 0.5 inches) larger than a corresponding length 220 and the corresponding width 222 of the receiving component 184. This may allow the screening component 182 to completely overlay the receiving component 184 when the screening and receiving components 182 and 184 are fully attached, and may prevent any of the larger unusable portions (e.g., chaff, straw) from reaching the receiving component 184 through gaps or crevices between the screening and receiving components 182 and 184.

Referring to FIGS. 2A, 2B, 5A, 5B, and 5C, the screening component 182 comprises a plurality of apertures 204 which can be used to separate the larger unusable portions in the sample received on the receptacle portion 180 from the smaller unusable portions and/or the smaller usable portions in the sample. In the embodiment shown, the apertures 204 comprise substantially square apertures and each aperture 204 has a width and a length of approximately 0.5 inches, resulting in each aperture 204 having a surface area of approximately 0.25 inches²; however, in other embodiments, each aperture 204 may have a width and a length ranging between approximately 0.1 inches and 1 inch, resulting in each aperture 204 having a surface area which ranges between approximately 0.01 inches² and 1 inch², and may further have a different shape (e.g., may be circular apertures, oval apertures, rectangular apertures, triangular apertures, etc.). The size of the apertures 204 may be selected based on a variety of factors, including one or more of a type of crop currently being harvested by the combine harvester 100 and the current weather at the field location 103. For example, larger apertures 204 may be used when the combine harvester 100 is harvesting crops having larger usable portions (e.g., sunflowers, soybeans, etc.), whereas smaller apertures 204 may be used when harvesting crops having smaller usable portions (e.g., wheat, barley, rye, etc.). As a further example, larger apertures 204 may be selected and used when the field location 103 is humid such that unusable portions of crops are more likely to stick to the usable portion of the crops, whereas one having smaller apertures 204 may be attached and used when the field location 103 is dry. The specific applicable size of the apertures 204, and variations thereof, will become apparent to those skilled in the art, particularly in view of the purpose of the screening component 182 for removing the larger unusable portions in the sample.

Referring to FIG. 5A, the screening and receiving components 182 and 184 are attached via at least one releasable attachment 206. The releasable attachment 206 may comprise any attachment that allows the screening and receiving components 182 and 184 to be at least partially detached after the screening component 182 has been used to remove the larger unusable portions (e.g., chaff, straw, etc.) in the sample.

In some embodiments (including the embodiment shown in FIGS. 2A, 2B, 5A, 5B and 5C), the releasable attachment 206 allows the screening and receiving components 182 and 184 to be partially detached. Partial detachment mechanisms may generally be used to ensure that the matching screening and receiving components 182 and 184 are not inadvertently or permanently separated. For example, referring to FIGS. 2A, 5A and 5B, the releasable attachment 206 comprises two features that allow respective top ends 205 and 225 of the screening and receiving components 182 and 184 to detach while their respective bottom ends 207 and 227 remain attached: (A) a set of elastic O-rings 210 (two are shown in FIGS. 5A and 5B) located proximate the top end 205 of the screening component 182 and configured to interact with, expand, and then frictionally engage, a set of corresponding posts 212 with enlarged heads (and stoppers which prevent the screening component 182 from falling completely down the posts 212) (two are shown in FIG. 5A) extending from a top surface 239 of a top sidewall 228 at a corresponding top end 225 of the receiving component 184; and (B) a set of hinges 214 (four are shown in FIGS. 5A and 5B) coupling the bottom end 207 of the screening component 182 with the corresponding bottom end 227 of the receiving component 184. As an additional example, referring to FIGS. 2B and 5C, the releasable attachment 206 comprises two features that allow respective top ends 205 and 225 of the screening and receiving components 182 and 184 to detach while their respective bottom ends 207 and 227 remain attached: (A) a set of elastic O-rings 210 (two are shown in FIGS. 2A and 5C) located proximate the top end 205 of the screening component 182 and configured to interact with, expand, and then frictionally engage, a set of corresponding posts 212 with enlarged heads (and stoppers which prevent the screening component 182 from falling completely down the posts 212) (two are shown in FIG. 2B) at the corresponding top end 225 of the receiving component 184; and (B) a set of extended hinges 514 (four are shown in FIG. 2B) coupling the bottom end 207 of the screening component 182 with the corresponding bottom end 227 of the receiving component 184. A height 513 of the set of extended hinges 514 may be larger than a height 213 of the set of posts 212 (heights 213 and 513 are shown in FIG. 2B), such that a separation distance between the corresponding bottom ends 207 and 227 of the screening and receiving components 182 and 184 is larger than a separation distance between the corresponding top ends 205 and 225 of the screening and receiving components 182 and 184. This enlarged separation at the bottom end creates a wider screening gap, allowing larger unusable portions of the crop to clear more easily while enabling the smaller usable portions to pass efficiently into the receiving component. As a result, the screening component 182 may filter more effectively and with reduced clogging, particularly in conditions where the discharged material contains larger or more irregular debris.

In operation, after the receptacle portion 180 is dropped on the ground 101 and receives the material discharged from the residue management unit 144, and after the operator manually agitates or rustles the sample of the material lying on top of the screening component 182, the larger unusable portions (e.g., chaff, straw, etc.) may remain on top of the screening component 182, while the smaller unusable portions (e.g., glumes, seed casings, hulls, etc.) and the smaller usable portions (e.g., grain, seed, etc.) may filter through the apertures 204 and be received in the receiving component 184. The operator may then partially detach the screening and receiving components 182 and 184 by using force to disengage the set of elastic O-rings 210 from the corresponding enlarged heads of the set of posts 212 and then opening the receptacle portion 180 by pivoting the screening component 182 relative to the receiving component at the set of hinges 214 or 514 (which may at the same time automatically discard the larger unusable portions on the screening component 182). In other embodiments, the releasable attachment 206 may comprise any attachment mechanism which allows the screening and receiving components 182 and 184 to be partially detached. For example, the respective top ends 205 and 225 may comprise a friction-based releasable attachment other than the set of elastic O-rings 210 and the set of posts 212. As an additional example, the respective top ends 205 and 225 may comprise magnet-based releasable attachments or vacuum suction-based releasable attachments, or other than the friction-based releasable attachment (i.e., the set of elastic O-rings 210 frictionally engaging with the set of posts 212).

However, in other embodiments (not shown), the releasable attachment 206 may allow the screening and receiving components 182 and 184 to be fully detached. Full detachment mechanisms may improve the ease of use of the receiving component 184 and may specifically improve the ability to transfer the usable portion to be measured into the calibrated container 402 of the mobile gauge system 110 (described below). For example, the releasable attachment 206 may not include the set of hinges 214 or 514. For example, the releasable attachment 206 may include separate sets of the elastic O-rings 210 located at both the top and bottom ends 205 and 207 of the screening component 182 and corresponding separate sets of the posts 212 located at both the top and bottom ends 225 and 227 of the receiving component 184. In yet other embodiments, both (or at least one) of the respective top ends 205 and 225 and the respective bottom ends 207 and 227 of the screening and receiving components 182 and 184 may comprise magnet-based releasable attachments, vacuum suction-based releasable attachments, or other types of friction-based releasable attachments. In yet other embodiments, the set of hinges 214 or 514 may specifically comprise detachable hinges (e.g., lift-off hinges, flag hinges, loose-pin hinges, etc.).

In some embodiments, and in particular where the releasable attachment 206 allows the screening and receiving components 182 and 184 to be fully detached, different screening components 182 may be combined with one particular receiving component 184 (or vice versa). For example, as described above, different screening components 182 may be selected based on one or more of a type of crop currently being harvested by the combine harvester 100 and the current weather at the field location 103. For example, a screening component 182 having larger apertures 204 may be attached to a particular receiving component 184 when the combine harvester 100 is harvesting crops having larger usable portions (e.g., sunflowers, soybeans, etc.), whereas one having smaller apertures 204 may be attached and used with the same particular receiving component 184 when harvesting crops having smaller usable portions (e.g., wheat, barley, rye, etc.). In other words, in some embodiments, the screening component 182 may be changed while the receiving component 184 may remain the same. In contrast, different receiving components 184 may be selected based on one or more of a size of the combine harvester 100 and a travel speed of the combine harvester 100. For example, a receiving component 184 having a larger height 224 (height 224 shown in FIG. 2A, described below) may be used with a particular screening component 182 when the loss measurement system 102 is used with larger combine harvesters 100 that may discharge a large amount of material; in contrast, a receiving component 184 having a smaller height 224 may be used with the same particular screening component 182 when the loss measurement system 102 is used with smaller combine harvesters 100 that may discharge less material. In other words, in some embodiments, the receiving component 184 may be changed while the screening component 182 remains the same.

### Receiving Component 184

Referring now to FIG. 5A, the receiving component 184 has the length 220 extending between the top end 225 and the bottom end 227, and the width 222 extending between a right end 221 and a left end 223. The receiving component 184 also has a height 224 (shown in FIG. 2A) generally corresponding to a height of a plurality of sidewalls 228 extending from a bottom wall 226. With the height 224 and the sidewalls 228, the receiving component 184 forms a receptacle or container for holding the remaining sample of the discharged material after it has been screened by the screening component 182 (in such cases, the remaining discharged material generally including the smaller unusable portions (e.g., glumes, seed casings, hulls, etc.) and the usable portions (e.g., grain, seed, etc.) of the material originally discharged by the residue management unit 144). In the embodiment shown, the length 220 is approximately 66 inches, the width 222 is approximately 12 inches, and the height 224 is approximately 1 inch; however, in other embodiments, the length 220 may range between approximately 24 inches and approximately 70 inches, the width 222 may range between approximately 10 inches and approximately 24 inches, and the height 224 may range between approximately 0.5 inches and 2 inches.

Generally, the length 220 and the width 222 of the receiving component 184 may be dimensioned based on the size of a combine harvester 100 that the loss measurement system 102 is attached to, and in particular the size of a discharge outlet associated with the residue management unit 144 of the combine harvester 100. For example, the length 220 of 66 inches may allow the receiving component 184 to be used with very large discharge outlets, including the 65-inch discharge outlet of the John Deere® X9 series. In some embodiments, the same large receiving component 184 may be used with smaller combine harvesters 100 having smaller discharge outlets, by virtue of: (A) the ability to mount the first and second rails 150 and 151 independently of each other and at different locations along the length 137 of various different combine structures 135; in combination with (B) the plurality of rail channels 236 formed on a bottom surface 237 (best shown in FIG. 5B) of the sidewalls 228 and which is adapted to receive at least one rail 104 (e.g., one or more of the first and second rails 150 and 151; in embodiments where at least two rails 104 are used, the at least two rails may also be separated by different separation distances 157 (shown in FIG. 4)) as described below. However, in some embodiments, the modular components of the loss measurement system 102 can allow the operator to switch out a larger receiving component 184 (e.g., 66 inches) for a smaller receiving component 184 (e.g., 46 inches, for use with a smaller combine harvester 100 having a discharge outlet of 45 inches) while still maintaining numerous other components of the loss measurement system 102, including the first and second rails 150 and 151 (or the single rail 450), the retention system 108 (described below), and potentially also the screening component 182 (described above, such as when the screening and receiving components 182 and 184 can be fully detached). The precise dimensions of the length 220, the width 222 and the height 224 of the receiving component 184, and variations therein, will become apparent to those skilled in the art, particularly in view of the interaction between the length 220 of the receiving component 184 and the size of the discharge outlet associated with the combine harvester 100.

Referring still to FIGS. 2A, 2B and 5A, as described above, the receiving component 184 includes the plurality of sidewalls 228 extending from the bottom wall 226 to generally form the receptacle or container for holding the sample of remaining material after it has been screened by the screening component 182. The sidewalls 228 include a right gap 231 proximate the right end 221 of the receiving component 184 and a left gap 233 proximate the left end 223. In the embodiment shown, the right and left gaps 231 and 233 are substantially identical, are both generally located at the same middle location along the length 220, and both have a width of approximately 3 inches, comprising approximately 30% of the length 220 of the receiving component 184. However, in other embodiments, the right and left gaps 231 and 233 may have different widths, may be located at different locations along the length 220, may (individually) have a width of between approximately 0.5 inches and approximately 6 inches (and in some embodiments may specifically range between approximately 1 inch and 1.5 inches), and may comprise anywhere between 10% and 80% of the length 220. In yet other embodiments, the receiving component 184 may only include one of the right and left gaps 231 and 233.

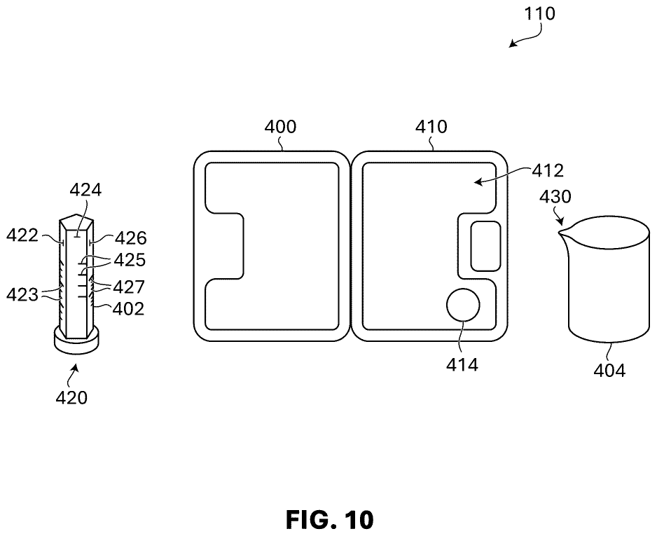

The right and left gaps 231 and 233 generally define a pour channel 234 of the receiving component 184 to facilitate transfer of any of the usable portions of sample to the calibrated container 402 (best shown in FIG. 10) to assess the amount of usable portion or grain which is present in the material discharged by residue management unit 144 of the combine harvester 100. A shape of the bottom wall 226 may be modified to facilitate use of the right and left gaps 231 and 233 as the pour channel 234. For example, in the embodiment shown in FIGS. 5A, 5B, and 5C, the bottom wall 226 is formed of a rigid polymer or metal material. The bottom wall 226 comprises fold lines 232, which may be a living hinge comprising a portion of decreased thickness of the same polymer material forming the rest of the bottom wall 226. In other embodiments, the fold lines 232 may be formed of different polymer or metal material, such as a more flexible or elastic polymer material, including without limitation, polypropylene, polyethylene, nylon, thermal plastic elastomer, etc. When the bottom wall 226 is folded along the fold lines 232, the bottom wall 226 forms a channel which shifts any sample remaining within the receiving component 184 to a middle portion of the bottom wall 226 defined between the fold lines 232 and to facilitate ease of transfer of the sample out of the receiving component 184 via at least one of the right and left gaps 231 and 233. More specifically, when the bottom wall 226 is folded along the fold lines 232, a top portion (proximate the top end 225) and a bottom portion (proximate the bottom end 227) of the bottom wall 226 form walls, while the middle portion of the bottom wall 226 stays flat. However, in other embodiments, the bottom wall 226 may comprise any material, or have any features, which allow the shape of the bottom wall 226 to be modified to facilitate use of at least one of the right and left gaps 231 and 233 as the pour channel 234. For example, the bottom wall 226 may only have a single fold line, such that when the bottom wall 226 is folded along the fold line, the bottom wall 226 has a V-shaped configuration. As an additional example, the bottom wall 226 may be formed of a flexible or elastic polymer material and may be formed to form a U-shaped configuration.

Referring now to FIGS. 5B and 5C, in some embodiments, the bottom surface 237 of the sidewalls 228 may extend slightly past a bottom surface 229 of the bottom wall 226. The bottom surface 237 of the sidewalls 228 may include at least one rail channel 236 sized to correspond to the width 153 or 453 of the at least one rail 104. In the embodiment shown in FIG. 5B, the at least one rail channel comprises a plurality of rail channels 236 which may be sized to correspond to the width 153 of the first and second rails 150 and 151 and may be positioned along the width 222 of the receiving component 184 to correspond to the separation distance 157 between the first and second rails 150 and 151 once mounted on the combine structure 135. For example, the bottom surface 237 includes 11 rail channels 236A-236K. Each of these rail channels 236A-236K have a corresponding width which allows each of these rail channels 236A-236K to receive a corresponding one of the first and second rails 150 and 151. In the embodiment shown, the width of each of the rail channels 236A-236K is the same and is each approximately 2 inches. However, those skilled in the art will appreciate that the width may vary depending on the size of the corresponding at least one rail 104 to be received therein, and that the width of each of the rail channels 236A-236K may be different (and may also correspondingly range between approximately 0.5 inches and approximately 12.5 inches). For example, rails 104 having a larger width 153 may be used (A) with larger combine harvesters 100; (B) where the separation distance 157 between the first and second rails 150 and 151 is small relative to the width 222 of the receiving component 184; and (C) in positions which allow the receptacle portion 180 to be supported on a single rail 104 (e.g., as described above, the central set of rail channels 236I, 236K and 236J). As a further example, rails 104 having a smaller width 153 may be used with smaller combine harvesters 100 or where the separation distance 157 is sufficient to support the entire width 222 of the receiving component 184.

Still referring to FIG. 5B, some of the rail channels 236 comprise the central set of rail channels (e.g., rail channels 236I, 236K and 236J) which may allow the receptacle portion 180 to be supported with a single rail 104. In the embodiment shown in FIG. 5C, the at least one rail channel comprises a single rail channel 236L which may also be centrally located relative to the width 222 of the receiving component 184 and may be sized to correspond to the width 453 of the single rail 450. However, referring back to FIG. 5B, some of the rail channels 236 comprise side sets of rail channels (e.g., rail channels 236A-236J) which are sized and positioned in sets of two to receive corresponding first and second rails 150 and 151. As shown, some rail channels 236 may form a part of both the central set and the side sets (e.g., rail channels 236I and 236J). The existence of separate sets of the rail channels 236A-236K allows the same large receiving component 184 (e.g., with the width 222 of 66 inches) to be used with at least one rail 104 (e.g., only a single one of, or both of, the first and second rails 150 and 151) which may be mounted at a variety of different first and second locations 139 and 141 along the length 137 of the combine structure 135 and which may have a variety of different separation distances 157 therebetween. In the embodiment shown, the side set of rail channels comprises five sets of rail channels. The first set comprises rail channels 236A and 236B, which have a large separation distance therebetween and which may allow the receiving component 184 to be used with first and second rails 150 and 151 that are mounted to the combine structure 135 having a correspondingly large separation distance 157 therebetween. The second set comprises rail channels 236C and 236D, the third set comprises rail channels 236E and 236F, the fourth set comprises rail channels 236G and 236H, and the fifth set comprises rail channels 236I and 236J. Each of these second to fifth sets have decreasingly smaller separation distances therebetween, and which allow the receiving component 184 to be used with first and second rails 150 and 151 that have correspondingly decreasingly smaller separation distances 157 therebetween. In some embodiments, any two of the plurality of rail channels 236A-236K may be used together depending on the first and second locations 139 and 141 that the first and second rails 150 and 151 are mounted onto a particular combine structure 135. The central set of rail channels comprises three rail channels 236I, 236J and 236K which are generally positioned in the middle of the width 222 of the receiving component 184, which may generally allow the receptacle portion 180 to be supported by a single rail 104.

However, in some embodiments (not shown), the bottom surface 237 of the sidewalls 228 may only include a single set of rail channels 236 or generally fewer sets of rail channels 236. For example, a particular receiving component 184 may only include two rail channels 236, and may specifically be sized for one separation distance 157. In other embodiments, a particular receiving component 184 may include two sets of rail channels 236 and may thus be configured for fewer separation distances 157 between first and second rails 150 and 151. Again, in the embodiment shown in FIG. 5C, the bottom surface 237 only includes the single rail channel 236L positioned such that the receiving component 184 is adapted to be supported by the single rail 450. The precise widths, position and number of the rail channels 236, and variations therein, will become apparent to those skilled in the art, particularly when considering the interactions between the width 222 of the receiving component 184, the size of the combine harvester 100, the configuration of the combine structure 135 affecting the separation distance 157 between the first and second rails 150 and 151.

Referring back to FIGS. 2A, 2B, 5A and 5B, as described above, the screening and receiving components 182 and 184 are attached via the releasable attachment 206. In the embodiment shown, the releasable attachment 206 allows the screening and receiving components 182 and 184 to be partially detached, and specifically comprises (A) the set of posts 212 with enlarged heads extending from the top surface 239 of the top sidewall 228 which is located at the top end 225 of the receiving component 184; and (B) the set of hinges 214 or 514 coupling the bottom end 207 of the screening component 182 with the bottom end 227 of the receiving component 184. As also described above, the set of posts 212 are configured to interact with, expand and frictionally engage with the elastic O-rings 210 located proximate the top end 205 of the screening component 182. The set of posts 212 includes the stoppers which prevent the screening component 182 from falling completely down the posts 212 when the screening and receiving components 182 and 184 are fully attached. However, as described above, in other embodiments, the releasable attachment 206 may comprise any attachment mechanism that allows the screening and receiving components 182 and 184 to be partially detached or to be fully detached, and may include magnet-based releasable attachments, vacuum suction-based releasable attachments, or other types of friction-based releasable attachments. The precise type and location (on the screening and receiving components 182 and 184) of the releasable attachment 206, and variations therein, will become apparent to those skilled in the art, particularly when considering the purpose of the screening component 182 for removing unusable portions of the sample collected on the receptacle portion 180 and the purpose of the receiving component 184 for receiving the usable portion of the sample.

### Retaining Component 186

Still referring to FIGS. 2B, 5A, 5B, and 5C, the retaining component 186 is generally configured, shaped, dimensioned and positioned to interact with the retention system 108 when the receptacle portion 180 is positioned on the at least one rail 104 and to allow the retention system 108 to release the receptacle portion 180 (separately from the cover portion 190) when in the partial release mode (shown in FIG. 1B).

In the embodiment shown in FIGS. 5A and 5B, the retaining component 186 comprises at least one rod extending from a side surface of the top sidewall 228 of the sidewalls 228 at the top end 225 of the receptacle portion 180 (and configured to face the combine harvester 100 when the loss measurement system 102 is mounted thereon). In the embodiment shown, the at least one rod comprises a first rod 240 located proximate the right end 221 of the receiving component 184 and a second rod 241 located proximate the left end 223. Generally, the first and second rods 240 and 241 are configured and positioned to interact with corresponding first and second receptacle retaining components 300 and 301 of the retention system 108 located on, respectively, the first and second rails 150 and 151. For clarity, only the second rod 241 will be described below; those skilled in the art will appreciate that the first rod 240 (or any other rods) may be configured in a similar manner.

The second rod 241 comprises a rod spaced apart from, and parallel with, the top surface of the top sidewall 228. In operation, the second rod 241 is configured to be retained by an actuatable hook 302 of the second receptacle retaining component 301 located on the second rail 151 (shown in FIGS. 2A, 4 and 9) when the retention system 108 is in the retain mode as described below. The second rod 241 is then released by the actuatable hook 302 when the actuatable hook 302 is rotated by a rotational actuator 304 (shown in FIGS. 2A, 3A, 4, 8A, 8B and 9) when the retention system 108 is in the partial release mode as described below.

Referring now to FIG. 5B, the second rod 241 has a diameter and a width 242, and may be operable to interact with the second receptacle retaining component 301 of the retention system 108 over the entire width 242. In the embodiment shown, the diameter is approximately 0.31 inches and the width 242 is approximately 6 inches; however, in other embodiments, the diameter may range between approximately 0.1 inches and 0.75 inches and the width 242 may range between approximately 2 inches and approximately 8 inches. The second rod 241 is generally configured to interact with the second receptacle retaining component 301. As described below, the second receptacle retaining component 301 may be positioned on or proximate the second rail 151. Those skilled in the art will appreciate that, in embodiments where the receiving component 184 includes the plurality of rail channels 236 which allow the receiving component 184 to receive the second rail 151 at various positions along the width 222 of the receiving component 184 (e.g., at the rail channels 236B, 236D, 236F, 236H, 236J and 236K), the width 242 of the second rod 241 may be similarly dimensioned or positioned to allow the second rod 241 to interact with the second receptacle retaining component 301 on the second rail 151 irrespective of where the second rail 151 is received. For example, in the embodiment shown in FIG. 5B, the width 242 of the second rod 241 is dimensioned to span all of the rail channels 236B, 236D, 236F, 236H, 236J and 236K at which the receptacle portion 180 may receive the second rail 151. Additionally, the width 242 of the second rod 241 is approximately 50% of the width 222 of the receiving component 184. The precise dimensions and locations of the first and second rods 240 and 241, and variations therein, will become apparent to those skilled in the art, particularly when considering the respective interactions between the first and second rods 240 and 241 and the first and second receptacle retaining components 300 and 301 located on the first and second rails 150 and 151. For example, in embodiments where the receptacle portion 180 is configured to be received on a single rail 104, the retaining component 186 may comprise a single rod located near a middle portion of the width 222 of the receiving component 184 and configured to interact with corresponding receptacle retaining components located on the single rail 104.

In the embodiment shown in FIGS. 2B and 5C, the retaining component 186 comprises the bottom wall 226 of the receiving component 184 of the receptacle portion 180 itself, and particularly the material of the bottom wall 226 operable to interaction with a receptacle retaining component 303 (e.g., at least one electromagnet 550) of the retention system 108. For example, the bottom wall 226 may be made of ferromagnetic metals such as at least one of iron, steel, nickel or cobalt.

Different embodiments of the retaining component 186 are described above. However, those skilled in the art will also appreciate that the retaining component 186 may be any other feature or structure which interacts with, and allows, the retention system 108 to retain the receptacle portion 180 when in the retain mode and to release the receptacle portion 180 when in the partial release mode. For example, the retaining component 186 may comprise a different magnet-based retaining component (e.g., at least one electromagnet positioned on or proximate the side surface of the top sidewall 228 or on the bottom surface 229 of the bottom wall 226), a vacuum suction-based retaining component, or some other mechanical-based retaining component (e.g., a piezoelectric gripper positioned on or proximate the side surface of the top sidewall 228), etc.

### Cover Portion 190

Referring now to FIGS. 2A, 2B, 6A, 6B and 7, the cover portion 190 is generally configured to cover and protect the receptacle portion 180 when all components of the collection pan 106 are retained by the retention system 108 on the at least one rail 104 (e.g., in the retain mode shown in FIG. 1A). In operation, when both the receptacle and cover portions 180 and 190 are retained on the at least one rail 104 (via the retaining component 186 of the receptacle portion 180 as described above and the retaining component 256 of the cover portion 190 as described below), material which may come into contact with the collection pan 106 (and which may fall into the receptacle portion 180 if it were not covered by the cover portion 190) may be any excess or loose material from operation of the combine harvester 100, rather than material which is discharged by the residue management unit 144. Such excess or loose material may fill the receptacle portion 180 prior to its being deposited onto the ground 101 away from the vehicle body 130, which may affect the ability of the receptacle portion 180 to function as an accurate gauge of loss of usable portion or grain. In contrast, when the cover portion 190 is separated from the receptacle portion 180 (e.g., in the partial release mode shown in FIGS. 1B), the receptacle portion 180 is exposed, which allows the screening and receiving components 182 and 184 thereof to receive the sample of the material discharged by the residue management unit 144.

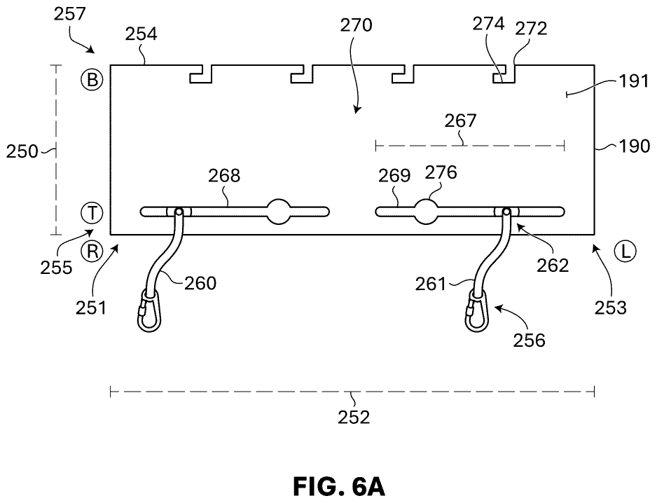

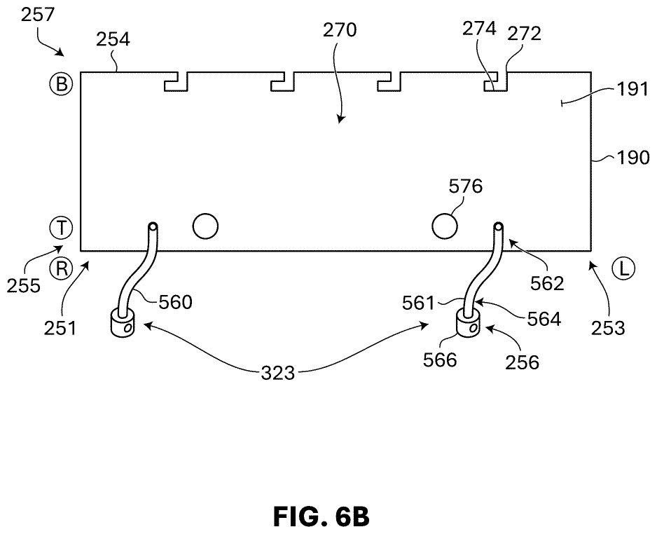

Referring now specifically to FIG. 6A, the cover portion 190 has a length 250 extending between a top end 255 and a bottom end 257, and a width 252 extending between a right end 251 and a left end 253. In the embodiment shown, the length 250 is approximately 13 inches, while the width 252 is approximately 66 inches; however, in other embodiments, the length 250 may range between approximately 10 inches and approximately 22 inches, while the width 252 may range between approximately 24 inches and approximately 70 inches. One or both of the length 250 and the width 252 of the cover portion 190 may be slightly larger than the corresponding length 220 and a corresponding width 222 of the receiving component 184 of the receptacle portion 180 with which the cover portion 190 is adapted to be coupled and to cover. This may allow the cover portion 190 to completely overlay the receiving component 184 when the cover portion 190 covers the receptacle portion 180 and may prevent any material from being received in the receptacle portion 180 through gaps or crevices therebetween. The precise dimensions of the length 250 and the width 252 of the cover portion 190, and variations therein, will become apparent to those skilled in the art, particularly in view of the interaction between the receptacle and cover portions 180 and 190, and the purpose of the cover portion 190 to cover the receptacle portion 180.

### Retaining Component 256

As briefly described above, the cover portion 190 comprises the retaining component 256, which is generally configured, shaped, dimensioned and positioned to retain the cover portion 190 both when in the retain mode (shown in FIG. 1A) and in the partial release mode (shown in FIG. 1B).

In the embodiment shown in FIGS. 2A and 6A, the retaining component 256 comprises first and second cords 260 and 261 extending from a body 191 of the cover portion 190. The first cord 260 is located proximate the right end 251 of the cover portion 190 and is generally positioned to interact with a first cover retaining component 320 (of the retention system 108 described below) located on the first rail 150. The second cord 261 is located proximate the left end 253 and is correspondingly positioned to interact with a second cover retaining component 321 (again of the retention system 108 described below) located on the second rail 151. In other embodiments, and particularly the embodiments where the cover portion 190 is adapted to be used with a receptacle portion 180 which is received on a single rail 104, the retaining component 256 may comprise only a single cord. For clarity, only the second cord 261 will be described below; however, those skilled in the art will appreciate that the first cord 260 (or any other cord) may be configured in a similar manner.

The second cord 261 extends from the body 191 and has a first end 262 movably retained (described below) in the body 191 and a second end 264 having a carabiner fastener attached thereto. The carabiner fastener allows the second end 264 to be clipped to a static hook 322 of a second cover retaining component 321 located on the second rail 151 (described below, shown in FIGS. 2A, 3A, 4, 8A, 8B and 9) when the retention system 108 is in both the retain mode and the partial release mode as described below. In the embodiment shown, the second cord 261 has a cord length of approximately 5 inches (and may be shortened or lengthened as described below); however, in other embodiments, the cord length may range between approximately 2 inches to approximately 10 inches. Those skilled in the art will appreciate that the cord length may be any length which allows the carabiner fastener to be hooked to the static hook 322 on the second rail 151 and thereafter to (A) cover the receptacle portion 180 when both the cover and receptacle portions 180 and 190 are received on the at least one rail 104 and the retention system 108 is in the retain mode and to (B) keep the cover portion 190 on the second rail 151 when the retention system is in the partial release mode.

The first end 262 is received in a slot 269 formed in the body 191 and is configured to be movable across a width 267 of the slot 269. The first end 262 may also include a tightening structure allowing the cord length to be shortened or lengthened, and which may also function as an enlarged portion for retaining the first end 262 in the slot 269, such as a spring-based clip located on an opposing side of the body 191. In the embodiment shown, the width 267 is approximately 30 inches; however, in other embodiments, the width 267 may range between approximately 0.5 inches to approximately 70 inches. The second cord 261 is generally configured to interact with the second cover retaining component 321. As described below, the second cover retaining component 321 may be positioned on the second rail 151. Those skilled in the art will appreciate that, in embodiments where the receiving component 184 (of a receptacle portion 180 to which the cover portion 190 is attached) includes the plurality of rail channels 236 which allow the receiving component 184 to receive the second rail 151 at various positions along the width 222 of the receiving component 184, the width 267 of the slot 269 may be similarly dimensioned or configured to allow the second cord 261 to be moved and to interact with the second cover retaining component 321 on the second rail 151 irrespective of which rail channel 236 the second rail 151 is received in. For example, in the embodiment shown in FIG. 6A, the width 267 of approximately 30 inches (combined with the cord length of approximately 5 inches) allows the first end 262 of the second cord 261 to be moved so that the carabiner fastener on the second end 264 is operable to interact with the static hook 322 on the second rail 151, irrespective of which rail channel 236B, 236D, 236F, 236H, 236J and 236K (shown in FIG. 5B) receives the second rail 151. The precise dimensions and locations of the first and second cords 260 and 261 (and the precise dimensions and locations of the corresponding slots 268 and 269 and cord if and as applicable), and variations therein, will become apparent to those skilled in the art, particularly when considering the interactions between the first and second cord 260 and 261 and the respective first and second cover retaining component 320 and 321 located on the first and second rails 150 and 151. For example, in embodiments where the receptacle portion 180 is received on a single rail 104, the retaining component 256 (of the cover portion 190) may comprise a single cord (without a corresponding slot) located near a middle of a width 252 of the cover portion 190 configured to interact with corresponding cover retaining components on the single rail 104.

In the embodiment shown in FIGS. 2B and 6B, the retaining component 256 comprises first and second cords 560 and 561 extending from the body 191 of the cover portion 190. The first cord 560 is located proximate the right end 251 of the cover portion 190. The second cord 561 is located proximate the left end 253. For clarity, only the second cord 561 will be described below; however, those skilled in the art will appreciate that the first cord 560 (or any other cord) may be configured in a similar manner.

The second cord 561 extends from the body 191 and has a first end 562 retained in the body 191 and a second end 564 having the magnet 566 attached thereto. The magnet 566 allows the second end 564 to be directly attached to the combine structure 135 in a manner similar to the magnet 462 of the mounting component 460 of the single rail 450 when the retention system 108 is in both the retain mode and the partial release mode as described below. In the embodiment shown, the second cord 561 has a cord length which is similar to, and which may be similarly adjustable as, the cord length of the second cord 261 described above.

Some embodiments of the retaining component 256 are described above. However, those skilled in the art will also appreciate that the retaining component 256 may be any other feature or structure which interacts with the component structure 135 and/or the retention system 108 to allow the cover portion 190 to be retained when in the retain mode and in the partial release mode, and optionally to release the cover portion 190 when in the full release mode (not shown). For example, the retaining component 256 may alternatively comprise a hydraulic or pneumatic-based retaining component, an electromechanical-based retaining component (e.g., powering a solenoid causes movement of a latch or other feature coupled to the cover portion 190), a spring-loaded mechanical retaining component, a vacuum suction-based retaining component, etc.

### Storage Features 270

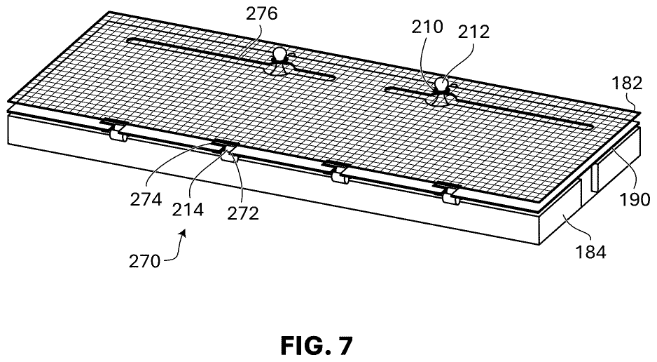

Referring now to FIGS. 6A, 6B and 7, the cover portion 190 further comprises at least one storage feature 270 which can be used to loosely couple the receptacle and cover portions 180 and 190 of the collection pan 106 together when not in use. For example, in the embodiment shown, the storage feature 270 includes: (A) a plurality of notches 272 (four are shown in FIGS. 6A and 6B) extending from a top edge 254 of the body 191 and a corresponding plurality of storage openings 274 extending from each notch 272 and spaced apart from the top edge 254, the notches 272 and the openings 274 generally configured to receive and retain the hinges 214 of the receptacle portion 180; and (B) enlarged openings 276 in the first and second slots 268 and 269, or enlarged openings 576 directly in the body 191 of the cover portion 190, generally configured to receive and retain the posts 212 of the receiving component 184. In operation, when the collection pan 106 is not in use, the operator may partially detach the screening component 182 from the receiving component 184 and open the receptacle portion 180 at the hinges 214. The operator may then insert the hinges 214 or 514 of the receptacle portion 180 into corresponding notches 272 of the cover portion 190 and shift the cover portion 190 laterally to retain the hinges 214 and 514 in the corresponding openings 274. The operator may then also insert the posts 212 into the enlarged openings 276 or 576 and then insert the post 212 also into the corresponding O-rings 210 of the screening component 182. Once the above steps are complete, referring to FIG. 7, the cover portion 190 may be inserted between the screening and receiving components 182 and 184 of the receptacle portion 180 and may be loosely coupled to the receptacle portion 180. The specific location and size of the notches 272, the openings 274, and the enlarged openings 276 and 576 and variations therein, will become apparent to those skilled in the art, particularly when considering the interactions between these storage features 270 and different existing components of the receptacle portion 180. Further, in other embodiments, storage features 270 may comprise any additional or alternative features which allow the receptacle and cover portions 180 and 190 to be loosely coupled for storage. For example, the storage features 270 may comprise hook-and-loop fastener features, weak magnet-based features, weak snap fastener-based features, weak suction-based features, etc.

### Retention System 108

Referring now to FIGS. 2A, 2B, 8A, 8B and 9, the loss measurement system 102 further includes the retention system 108. Generally, as described above, the retention system 108 is configured to switch between: (A) the retain mode in which both the receptacle and cover portions 180 and 190 of the collection pan 106 are retained on the at least one rail 104 (shown in FIG. 1A); (B) the partial release mode in which the cover portion 190 is retained on the at least one rail 104 but the receptacle portion 180 is released (shown in FIG. 1B); and (C) optionally, a full release mode in which the cover portion 190 is also released (not shown). In the embodiment shown, the retention system 108 includes the actuatable receptacle retaining components 300, 301 and 303 for releasably retaining the receptacle portion 180, a separate (optionally actuatable) cover retaining component 320, 321 and 323 for releasably retaining the cover portion 190, a power component 340 for powering one or more of the retaining components 300, 301, 303, 320, 321 and 323, and a controller component 360 for transmitting signals for causing the retention system 108 to switch between the retain, the partial release, and the full release modes. The different components 300, 301, 303, 320, 321, 323, 340 and 360 will now be described below.

### Receptacle Retaining Components 300, 301 and 303

Referring to FIGS. 2A and 4, in the embodiment shown, the first and second receptacle retaining components 300 and 301 are located on, respectively, the first and second rails 150 and 151. In this regard, being located on the first and second rails 150 and 151 allows the first and second receptacle retaining components 300 and 301 to be correspondingly repositioned when the first and second rails 150 and 151 are mounted to different combine structures 135 of different combine harvesters 100 or at different first and second locations 139 and 141 along the length 137 of the combine structure 135. This allows for ease of operation of the loss measurement system 102, as there is not a separate component that needs to be mounted on a combine harvester 100 aside from the first and second rails 150 and 151. The first and second receptacle retaining components 300 and 301 are actuated during a switch of the retention system 108 to release the receptacle portion 180. For clarity, only the second receptacle retaining component 301 will be described below; those skilled in the art will appreciate that the first receptacle retaining component 300 (or any other applicable receptacle retaining component located on any other rail 104) may be configured in a similar manner.

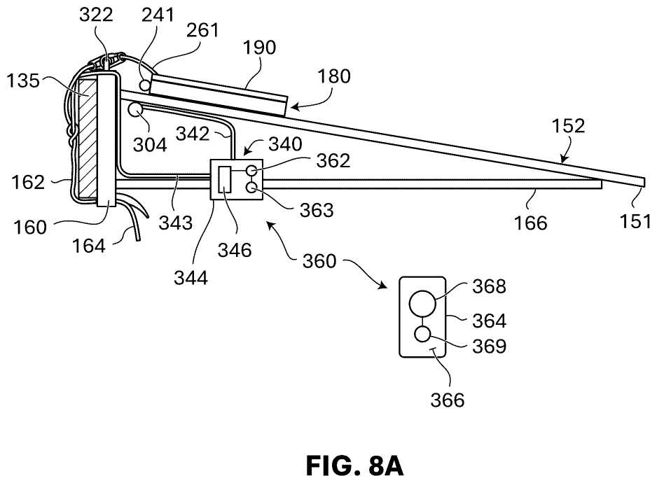

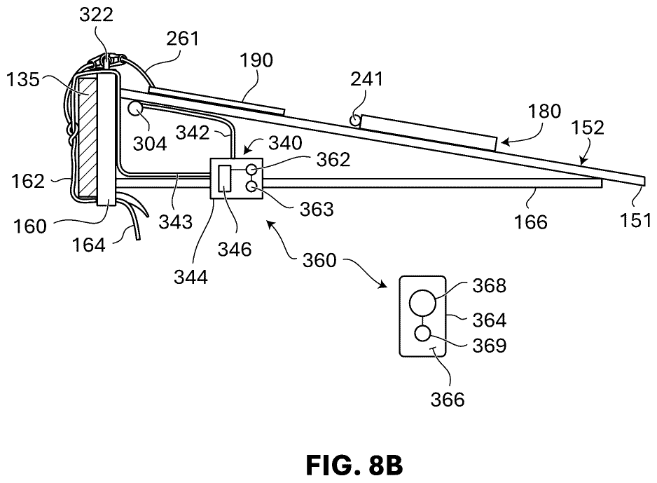

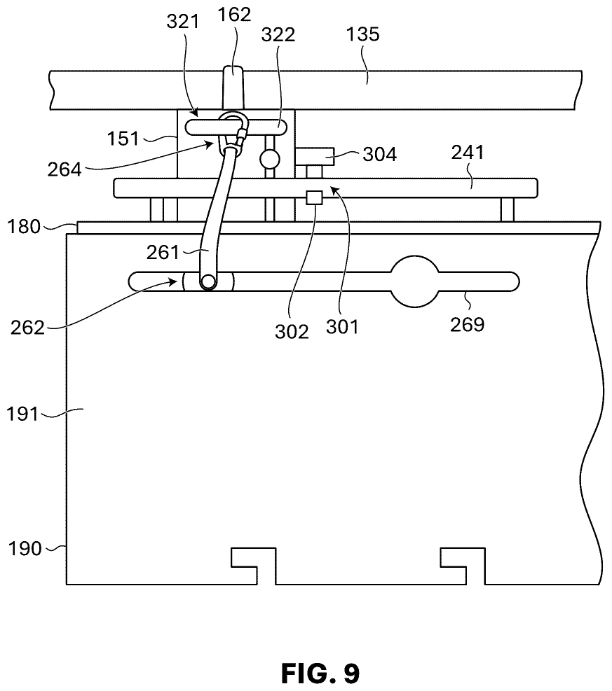

Referring to FIGS. 2A, 4, 8A, 8B and 9, as described above, the second receptacle retaining component 301 includes the actuatable hook 302 and the rotational actuator 304. In the embodiment shown, the actuatable hook 302 extends from the sliding component 152 of the second rail 151 and towards the first rail 150. The rotational actuator 304 is configured to rotate the actuatable hook 302 from a retaining configuration (shown in FIGS. 8A and 9) clockwise to a release configuration (shown in FIG. 8B), to thereby switch the retention system 108 from the retain mode to the partial release mode. The rotational actuator 304 may be responsive to a wireless signal transmitted by the controller component 360 as described below. In operation, the operator may hook the second rod 241 of the receptacle portion 180 onto the actuatable hook 302 when the actuatable hook 302 is in the retaining configuration (to thereby retain the receptacle portion 180 on the second rail 151). The operator may then operate the combine harvester 100 to harvest the crop and to discharge material from the vehicle body 130 via the residue management unit 144. During operation of the combine harvester 100, the operator may actuate the controller component 360, which may transmit a wireless signal to the retention system 108 to switch from the retain mode to the partial release mode. In response to the wireless signal, the rotational actuator 304 may rotate the actuatable hook 302 and release the receptacle portion 180, thereby causing the receptacle portion 180 to slide down the first and second rails 150 and 151 and be deposited on the ground 101. The precise dimensions, precise location, and the precise amount of rotational travel of the actuatable hook 302, and variations therein, will become apparent to those skilled in the art, particularly when considering the function of the actuatable hook 302 to releasably retain the receptacle portion 180 depending on the mode of the retention system 108. For example, in embodiments where the receptacle portion 180 is configured to be received on a single rail 104, the receptacle retaining component may comprise a single actuatable hook on the single rail 104 configured to retain and release the single rod located near the middle portion of the width 222 of the receiving component 184.

Referring to FIG. 2B, in the embodiment shown, the receptacle retaining component 303 is located on the sliding component 452 of the single rail 450. The receptacle retaining component 303 comprises the at least one electromagnet 550 (only one is shown in FIG. 2B) coupled to an upper surface of the sliding component 452, which is configured to magnetically retain the bottom wall 226 of the receptacle portion 180. The electromagnet 550 may generally be located at a center of the sliding component 452 (e.g., at or around a center of the width 453 and a center of the length 456), and is positioned and dimensioned to contact the bottom wall 226 when the receptacle portion 180 is received within the single rail channel 236L (shown in FIG. 5C). The electromagnet 550 may be responsive to a wireless signal transmitted by the controller component 360 as described below. In operation, the operator may attach the bottom wall 226 of the receptacle portion 180 directly to the electromagnet 550 when the single rail 450 is received within the single rail channel 236L of the receptacle portion 180. The operator may then operate the combine harvester 100 to harvest the crop and to discharge material from the vehicle body 130 via the residue management unit 144. During operation of the combine harvester 100, the operator may actuate the controller component 360, which may transmit a wireless signal to the retention system 108 to switch from the retain mode to the partial release mode. In response to the wireless signal, the electromagnet 550 may demagnetize and release the receptacle portion 180, thereby causing the receptacle portion 180 to slide down the single rail 450 and be deposited on the ground 101. The precise dimensions and precise location of the electromagnet 550, and variations therein, will become apparent to those skilled in the art, particularly when considering the function of the electromagnet 550 to releasably retain the receptacle portion 180 depending on the mode of the retention system 108.

Some embodiments of the receptacle retaining components 300, 301 and 303 are described above. However, those skilled in the art will appreciate that the receptacle retaining components 300, 301 and 303 may be any other component, feature or structure which is capable of interacting with the receptacle portion 180 and which is capable of switching between retaining and releasing the receptacle portion 180 in response to the wireless signal from a controller component 360 to switch the retention system 108 from the retain mode to the partial release mode. For example, the first and second receptacle retaining components 300 and 301 may comprise a vacuum suction-based retaining component, or some other mechanical-based retaining component (e.g., a piezoelectric gripper positioned on or proximate the sliding component 152 or 452), etc.

### Cover Retaining Components 320, 321 and 323

Referring to FIGS. 2A, 4, 8A, 8B and 9, in the embodiment shown, the cover retaining components 320 and 321 are also located on, respectively, the first and second rails 150 and 151. Being located on the first and second rails 150 and 151 also allows the cover retaining components 320 and 321 to be correspondingly repositioned when the first and second rails 150 and 151 are moved and mounted to different combine structures 135 of different combine harvesters 100. This again allows for ease of operation of the loss measurement system 102, as there is not a separate component that needs to be mounted aside from the first and second rails 150 and 151. Rather, all receptacle and cover retaining components 300, 301, 320 and 321 are repositioned together with a corresponding one of the first and second rails 150 and 151. The cover retaining components 320 and 321 are generally configured to remain static and continue to retain the cover portion 190 during the switch of the retention system 108 from the retain mode to the partial release mode and continue to retain the cover portion 190 in the partial release mode. In some embodiments (not shown), the cover retaining components 320 and 321 may be configured to release the cover portion 190 during the switch of the retention system 108 from the partial release mode to the full release mode. For clarity, only the second cover retaining component 321 will be described below; those skilled in the art will appreciate that the first cover retaining component 320 (or any other applicable cover retaining components located on any other rail 104) may be configured in a similar manner.

Still referring to FIGS. 2A, 4, 8A, 8B and 9, as described above, the second cover retaining component 321 comprises the simple static hook 322 which extends from the mounting component 160 of the second rail 151. The static hook 322 is generally configured to receive the carabiner fastener extending from the second end 264 of the second cord 261 of the cover portion 190, and is not responsive to the wireless signal transmitted by the controller component 360 to switch the retention system 108 from the retain mode to the partial release mode. In operation, the operator may clip the carabiner fastener extending from the second cord 261 to the static hook 322 (to thereby retain the cover portion 190 on the second rail 151), sliding the second cord 261 along the width 267 of the second slot 269 and adjusting the cord length of the second cord 261 by actuating the tightening structure on the first end 262 of the second cord 261 if and as applicable. The operator may then operate the combine harvester 100 to harvest the crop and to discharge material from the vehicle body 130 via the residue management unit 144. During operation of the combine harvester 100, the controller component 360 may transmit the wireless signal to the retention system 108 directing the retention system 108 to switch from the retain mode to the partial release mode. The static hook 322 may be unresponsive to the wireless signal and may continue to retain the cover portion 190 while the actuatable hook 302 releases the receptacle portion 180. The precise dimensions and the precise location of the static hook 322, and variations therein, will become apparent to those skilled in the art, particularly when considering the function of the static hook 322 to retain the cover portion 190 while the actuatable hook 302 is controlled to release the receptacle portion 180. For example, in embodiments where the receptacle portion 180 is configured to be received on a single rail 104, the cover retaining component may comprise a single static hook on the single rail 104 configured to retain and release a single cord (which may simply extend from the body 191 and may not be received in any slot) located near the middle portion of the width 252 of the cover portion 190.

Referring to FIGS. 2B and 5C, in the embodiment shown, the cover retaining component 323 is located on the first and second cords 560 and 561 of the cover portion 190. For clarity, only the cover retaining component 323 associated with the second cord 561 will be described below; those skilled in the art will appreciate that the first cord 560 may be configured in a similar manner.

Still referring to FIGS. 2B and 5C, as described above, the cover retaining component 323 comprises the magnet 566 attached to the second end 564 of the second cord 561, which is not responsive to the wireless signal transmitted by the controller component 360 to switch the retention system 108 from the retain mode to the partial release mode. In operation, the operator may attach the magnet 566 extending from the second cord 561 to the component structure 135 (to thereby retain the cover portion 190 on the single rail 450). The operator may then operate the combine harvester 100 to harvest the crop and to discharge material from the vehicle body 130 via the residue management unit 144. During operation of the combine harvester 100, the controller component 360 may transmit the wireless signal to the retention system 108 directing the retention system 108 to switch from the retain mode to the partial release mode. The magnet 566 may be unresponsive to the wireless signal and may continue to retain the cover portion 190 while the electromagnet 550 releases the receptacle portion 180. The precise dimensions and the precise location of the magnet 566, and variations therein, will become apparent to those skilled in the art, particularly when considering the function of the magnet 566 to retain the cover portion 190 while the electromagnet 550 is controlled to release the receptacle portion 180.

Embodiments of the cover retaining components 320, 321 and 323 are described above. However, those skilled in the art will appreciate that the cover retaining components 320, 321 and 323 may be any other feature or structure which interacts with the cover portion 190 and which allows the retention system 108 to retain the cover portion 190 in both the retain mode and the partial release mode. Further, in some embodiments (not shown), the cover retaining components 320, 321 and 323 may be responsive to another wireless signal from the controller component 360 directing the cover retaining components 320, 321 and 323 to then release the cover portion 190 in the full release mode. For example, the first and second cover retaining components 320 and 321 may comprise magnet-based retaining components (e.g., at least one electromagnet positioned on or proximate the sliding component 152 of the first and second rails 150 and 151), a vacuum suction-based retaining component, or other mechanical-based retaining component (e.g., a piezoelectric gripper positioned on or proximate the sliding component 152), etc. In another embodiment, the magnet 566 of the retaining component 323 may comprise an electromagnet configured to demagnetize in response to the further wireless signal from the controller component 360.

### Power Component 340

Referring to FIGS. 3A, 3B, 4, 8A and 8B, in the embodiment shown, the power component 340 is located on the second rail 151 or on the single rail 450. In this regard, similar to the rationale described above in association with the receptacle and cover retaining components 300, 301, 303, 320, 321 and 323, being located on the second rail 151 or on the single rail 450 allows the power component 340 to be correspondingly repositioned when the second rail 151 or the single rail 450 is mounted to different combine structures 135 of different combine harvesters 100. This again allows for ease of mounting and subsequent operation of the loss measurement system 102, as there is not a separate component that needs to be mounted on the combine harvester 100 aside from the second rail 151 (and optionally the first rail 150). The power component 340 generally functions to provide a source of power for powering one or more of the receptacle and cover retaining components 300, 301, 303, 320, 321 and 323 to allow the retention system 108 to switch between the retain mode and the partial release mode (and also optionally the full release mode in some embodiments). In the embodiment shown, only the receptacle retaining components 300, 301 and 303 are powered (i.e., the rotational actuators 304 and electromagnet 550); in contrast, the cover retaining components 320, 321 and 323 comprise unpowered structures (i.e., the static hooks 322 or the magnets 566). However, in other embodiments, the power component 340 may also power the cover retaining components 320, 321 and 323 in embodiments where the retention system 108 further includes the full release mode. In some other embodiments (not shown), the power component 340 may comprise first and second power components located on, respectively, the first and second rails 150 and 151 for powering, respectively, the first and second receptacle retaining components 300 and 301. Having separate power components which separately power the first and second receptacle retaining components 300 and 301 may further improve the modularity of the loss measurement system 102 as there is no need to thread a power connection 343 (described below) from the power component 340 located on the second rail 151 to the rotational actuator of the first receptacle retaining component 300 located on the first rail 150.

In the embodiment shown in FIGS. 3A, 4, 8A and 8B, the power component 340 is mounted on the support component 166 of the second rail 151. In the embodiment shown in FIG. 3B, the power component 340 is mounted directly on the sliding component 452. The power component 340 comprises a battery box 344 storing a battery 346. The battery box 344 protects the battery 346 from debris when the second rail 151 is mounted on the combine structure 135 and during operation of the combine harvester 100. The battery box 344 may be configured in standard plates for receiving the battery 346; the battery 346 may be a standard power-tool battery (e.g., 12V or 20V batteries from Milwaukee®, DeWalt®, or Makita®) configured with corresponding contacts to receive metal plates in the battery box 344. This allows the battery 346 to be a universal battery that is easily available to the operator, and may also be easily switched out and charged by the operator without requiring any further (or proprietary) chargers. In the embodiment shown in FIGS. 3A, 4, 8A and 8B, the battery 346 is connected to the rotational actuator 304 of the second receptacle retaining component 301 on the second rail 151 by a wired power connection 342 and is also connected to the rotational actuator of the first receptacle retaining component 300 (on the first rail 150) by a longer wired connection 343. The longer wired connection 343 may be extended across the support and mounting components 166 and 160 of the second rail 151, then behind the combine structure 135 to the first rail 150, and finally extended across the support and mounting components of the first rail 150 (best shown in FIG. 4). The wired power connections 342 and 343 allow the rotational actuators 304 to draw power from the power component 340 in response to the wireless signal from the controller component 360 to switch the retention system 108 from the retain mode to the partial release mode. In the embodiment shown in FIG. 3B, the battery 346 is connected to the electromagnet 550 also via a wired connection (not shown). The electromagnet 550 draws power from the power component 340 at baseline, and in response to the wireless signal from the controller component 360 to switch the retention system 108 from the retain mode to the partial release mode, the electromagnet 550 ceases to draw power from the power component 340 to thereby demagnetize the electromagnet 550.

The precise voltage of the battery 346, the precise dimensions and location of the battery box 344, and the cable type and length of the wired power connections 342 and 343, and variations therein, will become apparent to those skilled in the art, particularly when considering the function of the power component 340 to power the receptacle retaining components 300, 301 and 303 on the at least one rail 104 (and optionally also the cover retaining components 320, 321 and 323 in some embodiments).

Some embodiments of the power component 340 are described above. However, those skilled in the art will appreciate that the power component 340 may be any other power source which is able to provide power for actuatable elements of the retention system 108 to allow the retention system 108 to transition between the retain mode and the partial release mode (and optionally also to the full release mode). For example, the first and second power components may comprise small solar panels, fuel-cell powers, a mechanical or manual power generator, a thermal electric generator (e.g., which harvests heat generated by the combine harvester 100 during operation thereof), etc.

### Controller Component 360

Referring now specifically to FIGS. 3A, 3B, 8A and 8B, in the embodiment shown, the controller component 360 includes a controller 362 in communication with the power component 340, and a remote 364 operable to transmit wireless signals to the controller 362.

In the embodiment shown in FIGS. 3A, 8A and 8B, the controller 362 is also located on the second rail 151, and may specifically be located in the battery box 344 of the power component 340 mounted on the support component 166 of the second rail 151. In the embodiment shown in FIG. 3B, the controller 362 is also located on the single rail 450, and may specifically be located in the battery box 344 of the power component 340 mounted to the sliding component 452 of the single rail 450. As described above, being located on the second rail 151 or the single rail 450 allows the controller 362 to be correspondingly repositioned when the second rail 151 or the single rail 450 is mounted to different combine structures 135 of different combine harvesters 100. This again allows for ease of mounting and subsequent operation of the loss measurement system 102, as there is not a separate component that needs to be mounted on the combine harvester 100 aside from the second rail 151 (and optionally the first rail 150) or the single rail 450. The controller 362 is generally configured to control the supply of power from the power component 340 to the receptacle retaining components 300, 301 and 303 (and in particular the rotational actuators 304 and/or the electromagnet 550), and optionally also to the cover retaining components 320, 321 and 323 (in embodiments where the cover retaining components are also powered), and includes a corresponding receiver 363 configured to receive the wireless signal generated by the remote 364. In some other embodiments (not shown), such as in embodiments where the power component 340 comprises first and second power components mounted on, respectively, the first and second rails 150 and 151, the controller component 360 may similarly comprise first and second controllers located on, respectively, the first and second rails 150 and 151 for controlling the supply of power from, respectively, the first and second power components to, respectively, the first and second retaining components 300, 320 and 301 and 321 (although, in the embodiment shown, only the receptacle retaining components 300 and 301 are powered). Again, having separate controllers which separately control the supply of power from the first and second power components may further improve the modularity of the loss measurement system 102 as there is no need to thread the power connection 343 (described above) from the power component 340 located on the second rail 151 to the rotational actuator of the first receptacle retaining component 300 located on the first rail 150.

Referring to FIGS. 8A and 8B, the remote 364 has an independent housing 366 with a battery and a transmitter 369 therein. The remote 364 may be positioned remotely from the at least one rail 104 and the collection pan 106, for example in a cab of the combine harvester 100. In the embodiment shown, the remote 364 has a “release” button 368 located externally on the housing 366 which can be depressed by the operator to cause the remote 364 to generate the wireless signal and the transmitter 369 to transmit the wireless signal to the receiver 363 of the controller 362 to switch the retention system 108 from the retain mode to the partial release mode (to release the receptacle portion 180). In other embodiments (not shown), the remote 364 also has a “full release” button which can be depressed by the operator to cause the remote 364 to generate, and the transmitter 369 to transmit, the further wireless signal to the controller 362 to switch the retention system 108 from the partial release mode to the full release mode (to thereafter release the cover portion 190).

As described above, the controller 362 includes the receiver 363 configured to receive the wireless signal (and optionally the further wireless signal) from the transmitter 369 of the remote 364. In response to the wireless signal, the controller 362 may control supply of electrical power from the battery 346 to the receptacle retaining components 300, 301 and 303 (and optionally the cover retaining components 320, 321 and 323 in some embodiments), causing the rotational actuators 304 to rotate the actuatable hooks 302 or the electromagnet 550 to demagnetize and to release the receptacle portion 180. In operation, the operator may actuate the “release” button 368 of the remote 364 from the cab of the combine harvester 100 to indicate that the operator wishes to switch the retention system 108 from the retain mode to the partial release mode to perform a loss measurement with the loss measurement system 102. The operator's actuation of the “release” button 368 causes the remote 364 to generate and transmit the wireless signal to the controller 362, thereby causing the controller 362 to allow the battery 346 to supply electrical power to the receptacle retaining components 300 and 301 or to stop supplying electrical power to the receptacle retaining component 303.

Embodiments of the controller component 360 are described above. However, those skilled in the art will appreciate that the controller component 360 may be any other controller system including a wireless remote and controllers which can allow the operator to switch the retention system 108 from the retain mode to the partial release mode (and optionally from the partial release mode to the full release mode). For example, the controller component 360 may include a mobile application installed on a smartphone or other mobile computing device of the operator.

### Mobile Gauge System 110

Referring now to FIGS. 2A and 10, in some embodiments, the loss measurement system 102 may further include the mobile gauge system 110 which allows the operator to estimate an amount of usable portion loss (by measuring the usable portion collected in the receiving component 184) while at the field location 103. Some embodiments of the loss measurement system 102 may not include the mobile gauge system 110, and in such embodiments, the operator may simply weigh the usable portion (e.g., grain) from a sample collected in the receiving component 184. In other embodiments, the mobile gauge system 110 may also be used with other existing drop pan systems (e.g., those described in the Background section). In the embodiment shown, the measurement system 102 includes the carrying case 400, the calibrated container 402 and a funnel container 404.

Referring specifically to FIG. 10, the carrying case 400 comprises a body 410 including a cavity 412 sized and dimensioned for receiving the calibrated container 402 and the funnel container 404. An external surface of the body 410 may be a hard shell, to protect the calibrated container 402 contained in the cavity 412. The carrying case 400 may generally allow the operator to carry the calibrated and funnel containers 402 and 404 to various different field locations 103 and perform an initial estimate of usable portion loss (e.g., grain loss) from a sample collected in the receptacle portion 180. The carrying case 400 further includes a stand opening 414. The stand opening 414 is generally configured to receive, and frictionally engage, a bottom end 420 of the calibrated container 402 to allow the calibrated container to remain in a vertical configuration (shown in FIG. 2A) while measuring the usable portions (e.g., grain). The precise size of the body 410, the cavity 412 and the stand opening 414, and the material used to manufacture the body 410, and variations therein, will become apparent to those skilled in the art, particularly when considering the crop being harvested by the combine harvester 100.

Still referring to FIG. 10, the calibrated container 402 is configured to provide a rough estimate of grain volume for at least two different types of crops. For example, in the embodiment shown, the calibrated container 402 comprises a tube having a pentagonal cross-section (e.g., five-sides). Each side of the calibrated container 402 may include a corresponding plurality of markings thereon for measuring or otherwise estimating a volume of usable portion of a particular type of crop in the sample collected in the receptacle portion 180. For example, in the embodiment shown in FIG. 10, the calibrated container 402 includes a first side 422 with a plurality of markings 423 thereon representing volumes based on a grain size associated with barley, a second side 424 with a plurality of markings 425 thereon representing volumes based on a grain size associated with wheat, and a third side 426 with a plurality of markings 427 thereon representing volumes based on a grain size associated with rye. As will be appreciated by those skilled in the art, other sides of the calibrated container 402 may include markings based on other types of crops. The different sets of markings 423, 425 and 427 can represent the volume of usable portion per unit of collection area of the receptacle portion 180. In some embodiments, the unit of collection area of the receptacle portion corresponds to a length of the header 136 of the combine harvester 100 by the length 220 of the receiving component 184 of the receptacle portion 180 (shown in FIG. 5A). Using correlation data between the volume of the usable portion collected in the receiving component 184, the length of the header 136 of the combine harvester 100 for the specified length 220 of the receiving component 184, and a type of the crop, the volume of the usable portions in the calibrated container 402 can be used to determine grain loss in units of bushels per acre.

Although one specific embodiment of the calibrated container 402 is described above, those skilled in the art will appreciate that alternative calibrated containers 402 are possible, particularly in view of the purpose of the calibrated container 402 as capable of providing a rough measurement of at least two different types of crops. For example, other embodiments of the calibrated container 402 may have a different cross-section (e.g., circle, square, hexagonal, heptagonal, octagonal, etc.), may have markings associated with different crop types than those mentioned above (e.g., may include markings associated with sunflower seeds, soybeans, millet, etc.), or may include differently provided markings than those mentioned above (e.g., rather than markings on different sides of the calibrated container 402, the markings associated with different crops may be associated with different colors or different patterns).

Still referring to FIG. 10, the funnel container 404 may generally function as an intermediary for transferring the usable portion of the sample received in the receiving component 184 into the calibrated container 402. In this regard, the funnel container 404 generally includes a larger top opening when compared to the calibrated container 402 and includes a narrowed spout 430 to facilitate transfer of the usable portion received in the funnel container 404 into the calibrated container 402.

### Method 500

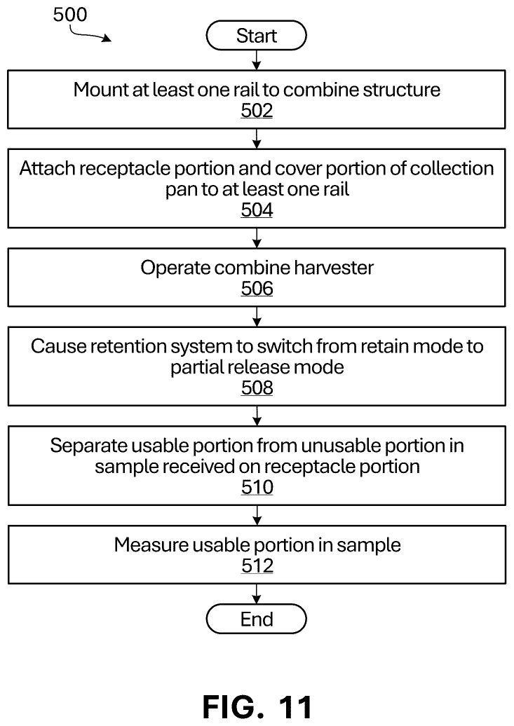

A method of measuring loss based on material discharged from the combine harvester 100 in accordance with one embodiment is shown generally at 500 in FIG. 11. At step 502, the operator may mount the at least one rail 104 to the combine structure 135. More specifically, the operator may independently mount the first and second rails 150 and 151 to the different first and second locations 139 and 141 along the length 137 of the combine structure 135. For example, the operator may extend the corresponding cables 162 of the first and second rails 150 and 151 over the combine structure 135 and tighten the cables 162 using the respective cable tighteners 164. The separation distance 157 between the first and second locations 139 and 141 may be based on the type and configuration of the combine structure 135 as described above. Alternatively, the operator may mount the single rail 450 to the selected location 143 along the length 137 of the combine structure 135.

At step 504, the operator may then attach the collection pan 106 to the retention system 108 located on the at least one rail 104. To attach the collection pan 106, the operator may specifically attach the receptacle portion 180 to the first and second receptacle retaining components 300 and 301 on, respectively, the first and second rails 150 and 151 or may attach the receptacle portion 180 to the receptacle retaining component 303 on the single rail 450.

For attachment to the first and second rails 150 and 151, step 504 may involve (a) receiving the first and second rails 150 and 151 into respective rail channels 236 located on a bottom of the receiving component 184 (of the receptacle portion 180) and (b) hooking the first and second rods 240 and 241 on the receptacle portion 180 to corresponding actuatable hooks 302 extending from the first and second rails 150 and 151. The operator may then attach the cover portion 190 to the first and second cover retaining components 320 and 321 on, respectively, the first and second rails 150 and 151. This may involve clicking the carabiner fastener extending from the first and second cords 260 and 261 of the cover portion 190 to the corresponding static hook 322 on the first and second rails 150 and 151. Attaching both the receptacle portion 180 and the cover portion 190 to the retention system 108 may place the retention system 108 into the retain mode.

For attachment to the single rail 450, step 504 may involve receiving the central rail 450 into the single rail channel 236L located on a bottom of the receiving component 184 (of the receptacle portion 180) to thereby magnetically attach the bottom wall 226 of the receiving component 184 to the central rail 450. The operator may then attach the cover portion 190 to the combine structure 135 via the cover retaining component 323, which may involve magnetically attaching the first and second cords 560 and 561 to the surface of the combine structure 135 via the magnets 566. Attaching both the receptacle portion 180 and the cover portion 190 via the retention system 108 may place the retention system 108 into the retain mode.

At step 506, the operator may enter the cab of the combine harvester 100 and operate the combine harvester 100 to harvest the crop with the retention system 108 in the retain mode. In this regard, the combine harvester 100 may be driven in the direction of travel 105 along the ground 101 at the field location 103 so that the header 136 cuts the crop, and the feederhouse 138, threshing unit 140 and shoe 142 work to separate the unusable portions of the crop from the usable portions of the crop. The (primarily) unusable portions of the crop may then be discharged by the residue management unit 144 from the rear portion 134 of the combine harvester 100.

While the operator is operating the combine harvester 100, the method 500 may then proceed to step 508, which may involve causing the retention system 108 to switch from the retain mode into the partial release mode. This may be done by the operator pressing the “release” button 368 of the remote 364. This causes the transmitter 369 of remote 364 to transmit the wireless signal to the controller 362 for receipt by the receiver 363. In some embodiments, in response to the wireless signal, the controller 362 causes the battery 346 to supply power to the first and second receptacle retaining components 300 and 301, specifically causing the rotational actuators 304 to rotate the actuatable hooks 302 to release the first and second rods 240 and 241. In other embodiments, in response to the wireless signal, the controller 362 causes the battery 346 to cease to supply power to the receptacle retaining component 303, specifically causing the demagnetization of the electromagnet 550. This subsequently causes the receptacle portion 180 to slide along the respective sliding components 152 of the first and second rails 150 and 151 or along the sliding component 452 of the single rail 450 before being dropped on the ground 101 a distance behind the vehicle body 130 of the combine harvester 100. The respective rail channels 236 located on the bottom of the receiving component 184 may guide and stabilize the receptacle portion 180 during its movement down the sliding component 152 or 452. While the receptacle portion 180 is on the ground 101, it receives the sample of the material discharged by the residue management unit 144 of the combine harvester 100.

At step 510, the operator may collect the receptacle portion 180 having the sample positioned thereon. The operator may use the screening component 182 (of the receptacle portion 180) to remove the larger unusable portions in the sample from the usable portions and potentially also the smaller unusable portions in the sample. The operator may then partially detach the screening component 182 from the receiving component 184 and further manually remove the remaining unusable portions from the usable portions in the sample using the bottom wall 226 of the receiving component 184 as a pan. The operator may then fold the receiving component 184 along the at least one fold line 232 and pour the remaining usable portions in the sample into the funnel container 404 of the mobile gauge system 110.

After some potential further sorting and removal of any remaining unusable portions from the funnel container 404, the operator may then pour the remaining usable portions from the funnel container 404 into the calibrated container 402 at step 512. The operator may then use the markings 423, 425 and 427 (depending on the type of crop currently being harvested by the combine harvester 100 at step 506) to provide an initial estimate of how much usable portion of the crop is being discharged by the combine harvester 100 via the residue management unit 144. The operator may then make suitable adjustments to the configuration or operation of the combine harvester 100 including the configuration of the threshing unit 140 or the shoe 142 or the blower speed of the residue management unit 144 for example to minimize the amount of usable portion loss during normal operation of the combine harvester 100.

When it is desirable to gauge the usable portion loss of a different combine harvester 100, the operator may remove the first and second rails 150 and 151 from the combine structure 135 and mount them to another combine structure 135 of another combine harvester 100 and repeat the process from step 502.

While specific embodiments have been described and illustrated, such embodiments should be considered illustrative of the subject matter described herein and not as limiting the claims as construed in accordance with the relevant jurisprudence.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A loss measurement system for use in combination with a combine harvester operable to cut a crop to be harvested, separate usable portions of the crop from unusable portions of the crop, and discharge material comprising both the usable portions and the unusable portions, the system comprising:
at least one rail mounted to a rear portion of the combine harvester;
a collection pan configured to be slidably received on the at least one rail, the collection pan comprising:
a receptacle portion for receiving a sample of the material discharged from the combine harvester; and
a cover portion for covering the receptacle portion; and
a retention system configured to retain both the receptacle portion and the cover portion of the collection pan, the retention system operable to switch between at least:
a retain mode in which the retention system retains both the receptacle portion and the cover portion; and
a partial release mode in which the retention system releases the receptacle portion and retains the cover portion, causing the receptacle portion to slide along the at least one rail and causing separation of the cover portion and the receptacle portion to allow the receptacle portion to receive the sample.

2. The system according to claim 1, wherein the at least one rail comprises at least two rails, wherein a rail of the at least two rails is operable to be mounted to a location on a combine component of the combine harvester independently of another rail of the at least two rails.

3. The system according to claim 1, wherein the at least one rail comprises one rail operable to be mounted to a location on a combine component of the combine harvester via a mounting component.

4. The system according to claim 3, wherein the mounting component comprises at least one of a binding-based mounting component, a magnet-based mounting component, and a vacuum-suction-based mounting component.

5. The system according to claim 1, wherein the receptacle portion comprises at least one rail channel configured to receive the at least one rail.

6. The system according to claim 1, wherein the at least one rail comprises a sliding component, wherein when the at least one rail is mounted to the rear portion of the combine harvester, the sliding component is positioned at an acute angle relative to a ground over which the combine harvester travels.

7. The system according to claim 1, wherein the receptacle portion comprises a screening component configured to facilitate separation of the usable portions in the sample from the unusable portions in the sample.

8. The system according to claim 7, further comprising a mobile gauge system comprising a carrying case and a calibrated container for receiving the usable portions in the sample received on the receptacle portion, wherein the carrying case is configured to carry the calibrated container when closed and to retain the calibrated container in a vertical position when opened.

9. The system according to claim 8, wherein the receptacle portion comprises at least one fold line to facilitate transfer of the usable portions in the sample from the receptacle portion to the calibrated container.

10. The system according to claim 1, wherein the retention system comprises a receptacle retaining component configured to retain and release the receptacle portion in response to a wireless signal from a controller and a cover retaining component configured to retain the cover portion independently of the receptacle retaining component.

11. The system according to claim 10, wherein the cover retaining component is further configured to release the cover portion in response to a further wireless signal from the controller.

12. The system according to claim 11, wherein the retention system is operable to switch between the retain mode, the partial release mode and a full release mode in which the retention system releases both the receptacle portion and the cover portion.

13. The system according to claim 10, wherein the receptacle retaining component comprises at least one of:
an actuatable hook configured to rotate in response to the wireless signal from the controller; and
an electromagnet configured to demagnetize in response to the wireless signal from the controller.

14. The system according to claim 1, wherein, after the receptacle portion slides along the at least one rail, the receptacle portion is deposited onto a ground over which the combine harvester travels.

15. A method of measuring loss based on material discharged from a combine harvester, wherein the combine harvester is operable to cut a crop to be harvested, separate usable portions of the crop from unusable portions of the crop, and discharge material comprising both the usable portions and the unusable portions, the method comprising:
causing a retention system to switch from a retain mode in which the retention system retains both a receptacle portion and a cover portion of a collection pan and a partial release mode in which the retention system releases the receptacle portion and retains the cover portion,
wherein, when the retention system is in the retain mode, the receptacle portion is covered by the cover portion, and
wherein, when the retention system is in the partial release mode, the receptacle portion slides along at least one rail mounted to a rear portion of the combine harvester and is separated from the cover portion to allow the receptacle portion to receive a sample of the material discharged from the combine harvester.

16. The method of claim 15, wherein:
when the at least one rail comprises at least two rails, the method further comprises independently mounting each rail of the at least two rails to different locations on a combine component of the combine harvester; and
when the at least one rail comprises one rail, the method further comprises mounting the one rail to a location on the combine component.

17. The method of claim 15, the method further comprising:
attaching the collection pan to the retention system; and
slidably receiving the at least one rail in a corresponding at least one rail channel of a plurality of rail channels on a bottom surface of the receptacle portion.

18. The method of claim 15, wherein attaching the collection pan to the retention system comprises:
attaching the receptacle portion to a receptacle retaining component of the retention system, wherein the receptacle retaining component is configured to retain and release the receptacle portion in response to a wireless signal from a controller; and
attaching the cover portion to a cover retaining component of the retention system, wherein the cover retaining component is configured to retain the cover portion independently of the receptacle retaining component.

19. The method of claim 15, the method further comprising:
separating the usable portions in the sample from the unusable portions in the sample using a screening component of the receptacle portion; and
folding the receptacle portion along at least one fold line to change a shape of a bottom surface of a receiving component of the receptacle portion to facilitate transfer of the usable portions in the sample to a mobile gauge system.

20. A collection pan for use in combination with a combine harvester operable to cut a crop to be harvested, separate usable portions of the crop from unusable portions of the crop, and discharge material comprising both the usable portions and the unusable portions, the collection pan configured to be slidably received on at least one rail mounted to a combine component of the combine harvester and the collection pan comprising:
a receptacle portion for receiving a sample of the material discharged from the combine harvester, and configured to be coupled to a retention system; and
a cover portion for covering the receptacle portion and configured to be coupled to the retention system,
wherein the cover portion covers the receptacle portion when the retention system retains both the cover portion and the receptacle portion, and
wherein the receptacle portion slides along the at least one rail and the cover portion is separated from the receptacle portion to allow the receptacle portion to receive the sample when the retention system retains the cover portion and releases the receptacle portion.
